(19) United States
(12) Patent Application Publication
(10) Pub. No.: US 2026/0148352 A1
(43) Pub. Date: May 28, 2026

(54) IMAGE ANALYSIS FOR OBJECT IDENTIFICATION

(71) Applicant: STMicroelectronics International N.V., Geneva (CH)

(72) Inventor: Alessandro Paolo BRAMANTI, Maglie (IT)

(21) Appl. No.: 19/395,701

(22) Filed: Nov. 20, 2025

Related U.S. Application Data
(60) Provisional application No. 63/725,273, filed on Nov. 26, 2024.

(51) Int. Cl. G06T 5/70; G06T 5/20

(52) U.S. Cl. CPC G06T 5/70; G06T 5/20; G06T 2207/20084

(57) ABSTRACT

In accordance with various embodiments of the present disclosure, a computer-implemented method for image analysis is provided. In some embodiments, the method comprises acquiring an image to be analyzed, the image having a first resolution; blurring the acquired image to create a blurred image having a second resolution less than the first resolution; performing one or more image analysis actions on the blurred image; storing results of the one or more image analysis actions performed on the blurred image as part of a neural fingerprint of the acquired image; performing one or more image analysis actions on one or more portions of the acquired image; and storing results of the one or more image analysis actions performed on one or more portions of the acquired image as part of the neural fingerprint of the acquired image.

### CROSS-REFERENCE TO RELATED APPLICATIONS

This application claims priority to and the benefit of U.S. Provisional Patent Application Ser. No. 63/725,273, filed Nov. 26, 2024, and titled “IMAGE ANALYSIS FOR OBJECT IDENTIFICATION,” which is incorporated herein by reference in its entirety.

### FIELD OF THE INVENTION

Example embodiments of the present disclosure relate generally to artificial vision and, more particularly, to image analysis for object identification.

### BACKGROUND

Artificial vision is essential for any machine which should interact with the environment in human-like way (autonomous robots, self-driving cars, etc.). Presently, deep neural networks are trained for artificial vision. However, even when they are effective at recognizing images, their training is long. That is because, for example, artificial neural networks crunch data from scratch to find regularities. That is also because some artificial vision systems analyze each image in its entirety and at high resolution.

Applicant has identified many technical challenges and difficulties associated with artificial vision. Through applied effort, ingenuity, and innovation, Applicant has solved problems related to artificial vision by developing solutions embodied in the present disclosure, which are described in detail below.

### BRIEF SUMMARY

Various embodiments described herein related to methods, apparatuses, and computer program products for image analysis.

In accordance with various embodiments of the present disclosure, a computer-implemented method for image analysis is provided. In some embodiments, the method comprises acquiring an image to be analyzed, the image having a first resolution; blurring the acquired image to create a blurred image having a second resolution less than the first resolution; performing one or more image analysis actions on the blurred image; storing results of the one or more image analysis actions performed on the blurred image as part of a neural fingerprint of the acquired image; performing one or more image analysis actions on one or more portions of the acquired image; and storing results of the one or more image analysis actions performed on one or more portions of the acquired image as part of the neural fingerprint of the acquired image.

In some embodiments, blurring the acquired image comprises convoluting the acquired image with larger kernels.

In some embodiments, performing one or more image analysis actions on the blurred image comprises decomposing one or more borders of the blurred image into linear pieces; decomposing the one or more borders of the blurred image into one or more other, non-linear shapes; and storing the one or more other, non-linear shapes as part of the neural fingerprint of the acquired image.

In some embodiments, performing one or more image analysis actions on the blurred image further comprises identifying one or more centers of symmetry of the blurred image, one or more medial axes of the blurred image, and/or one or more medial blobs of the blurred image.

In some embodiments, performing one or more image analysis actions on the blurred image further comprises detecting a shape of each of the one or more medial axes of the blurred image.

In some embodiments, performing one or more image analysis actions on the blurred image further comprises decomposing the one or more medial axes of the blurred image and/or the one or more medial blobs of the blurred image into linear pieces; decomposing the one or more medial axes of the blurred image and/or the one or more medial blobs of the blurred image into one or more other, non-linear shapes; and storing the one or more other, non-linear shapes as part of the neural fingerprint of the acquired image.

In some embodiments, performing one or more image analysis actions on the blurred image further comprises finding a centroid of each of the one or more medial axes of the blurred image and/or each of the one or more medial blobs of the blurred image; and performing one or more image analysis actions on one or more portions of the acquired image comprises, for each of the one or more medial axes of the blurred image and/or each of the one or more medial blobs of the blurred image, (i) centering a visual field on a portion of the acquired image corresponding to the centroid of a selected one of (a) the one or more medial axes of the blurred image or (b) the one or more medial blobs of the blurred image, (ii) decomposing the portion of the acquired image upon which the visual field is centered into linear pieces (iii) decomposing the portion of the acquired image upon which the visual field is centered into one or more other, non-linear shapes, and (iv) storing the one or more other, non-linear shapes as part of the neural fingerprint of the acquired image.

In accordance with various embodiments of the present disclosure, an apparatus for image analysis is provided. In some embodiments, the apparatus comprises at least one processor and at least one non-transitory memory comprising program code. In some embodiments, the at least one non-transitory memory and the program code are configured to, with the at least one processor, cause the apparatus to at least acquire an image to be analyzed, the image having a first resolution; blur the acquired image to create a blurred image having a second resolution less than the first resolution; perform one or more image analysis actions on the blurred image; store results of the one or more image analysis actions performed on the blurred image as part of a neural fingerprint of the acquired image; perform one or more image analysis actions on one or more portions of the acquired image; and store results of the one or more image analysis actions performed on one or more portions of the acquired image as part of the neural fingerprint of the acquired image.

In accordance with various embodiments of the present disclosure, a computer program product for image analysis is provided. In some embodiments, the computer program product comprises at least one non-transitory computer-readable storage medium having computer-readable program code portions stored therein. In some embodiments, the computer-readable program code portions comprises an executable portion configured to acquire an image to be analyzed, the image having a first resolution; blur the acquired image to create a blurred image having a second resolution less than the first resolution; perform one or more image analysis actions on the blurred image; store results of the one or more image analysis actions performed on the blurred image as part of a neural fingerprint of the acquired image; perform one or more image analysis actions on one or more portions of the acquired image; and store results of the one or more image analysis actions performed on one or more portions of the acquired image as part of the neural fingerprint of the acquired image.

In accordance with various embodiments of the present disclosure, a system for analyzing an image is provided. In some embodiments, the system comprises a visual data acquisition module for acquiring the image to be analyzed; a lateral geniculate nucleus (LGN) module for processing the image provided by the visual data acquisition module by passing the image through a bank of filters with a center-surround excitatory/inhibitory connection distribution; a Gabor filters module for detecting a plurality of linear pieces of a border of an object in the image; a V1 module for detecting a plurality of pieces of the border of a first complexity; a V2 module for aggregating outputs of the V1 module to detect a plurality of pieces of the border that are larger and more complex than the plurality of pieces detected by the V1 module; a V4 module for aggregating outputs of the V2 module to detect a plurality of pieces of the border larger and more complex than the plurality of pieces detected by the V2 module; a V3 module for aggregating groups of adjacent outputs from the V2 module over variable areas; and an attractor finder module for locating groups of adjacent V3 cells whose response exceeds a predetermined threshold.

The above summary is provided merely for purposes of summarizing some example embodiments to provide a basic understanding of some aspects of the disclosure. Accordingly, it will be appreciated that the above-described embodiments are merely examples and should not be construed to narrow the scope or spirit of the disclosure in any way. It will also be appreciated that the scope of the disclosure encompasses many potential embodiments in addition to those here summarized, some of which will be further described below.

### BRIEF DESCRIPTION OF THE DRAWINGS

The description of the illustrative embodiments may be read in conjunction with the accompanying figures. It will be appreciated that, for simplicity and clarity of illustration, elements illustrated in the figures have not necessarily been drawn to scale, unless described otherwise. For example, the dimensions of some of the elements may be exaggerated relative to other elements, unless described otherwise. Embodiments incorporating teachings of the present disclosure are shown and described with respect to the figures presented herein, in which:

FIG. 1 illustrates an example block diagram of an example system for image analysis, in accordance with some embodiments of the present disclosure;

FIGS. 2A and 2B illustrates an example flow diagram illustrating an example method for image analysis, in accordance with some embodiments of the present disclosure;

FIG. 3 is a simplified example image to be analyzed and an illustration of various steps of an image analysis process, in accordance with an example embodiment of the present disclosure;

FIG. 4 illustrates an example unidirectional (analog) network for creating a weighted input sum;

FIGS. 5-9 illustrate various aspects of feedback networks of an example system for image analysis, in accordance with example embodiments of the present disclosure;

FIGS. 10-14 illustrate various aspects of lateral connections of an example system for image analysis, in accordance with example embodiments of the present disclosure;

FIGS. 15-21 illustrate various aspects of variable-resolution cells for attentive/pre-attentive processing of an example system for image analysis, in accordance with example embodiments of the present disclosure;

FIG. 22 illustrates various aspects of Gabor filters of an example system for image analysis, in accordance with example embodiments of the present disclosure;

FIGS. 23-26 illustrate various aspects of artificial non-linear neurons of an example system for image analysis, in accordance with example embodiments of the present disclosure;

FIG. 27-30 illustrate various aspects of segmentation cells of an example system for image analysis, in accordance with example embodiments of the present disclosure;

FIG. 31 illustrates additional details of artificial non-linear neurons of an example system for image analysis, in accordance with example embodiments of the present disclosure; and

FIGS. 32-35 illustrate various aspects of time-responsive artificial non-linear neurons of an example system for image analysis, in accordance with example embodiments of the present disclosure.

### DETAILED DESCRIPTION OF THE INVENTION

Some embodiments of the present disclosure will now be described more fully hereinafter with reference to the accompanying drawings, in which some, but not all embodiments of the disclosure are shown. Indeed, these disclosures may be embodied in many different forms and should not be construed as limited to the embodiments set forth herein; rather, these embodiments are provided so that this disclosure will satisfy applicable legal requirements. Like numbers refer to like elements throughout.

As used herein, terms such as “front,” “rear,” “top,” etc. are used for explanatory purposes in the examples provided below to describe the relative position of certain components or portions of components. Furthermore, as would be evident to one of ordinary skill in the art in light of the present disclosure, the terms “substantially” and “approximately” indicate that the referenced element or associated description is accurate to within applicable engineering tolerances.

As used herein, the term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of.

The phrases “in one embodiment,” “according to one embodiment,” and the like generally mean that the particular feature, structure, or characteristic following the phrase may be included in at least one embodiment of the present disclosure, and may be included in more than one embodiment of the present disclosure (importantly, such phrases do not necessarily refer to the same embodiment).

The word “example” or “exemplary” is used herein to mean “serving as an example, instance, or illustration.” Any implementation described herein as “exemplary” is not necessarily to be construed as preferred or advantageous over other implementations.

If the specification states a component or feature “may,” “can,” “could,” “should,” “would,” “preferably,” “possibly,” “typically,” “optionally,” “for example,” “often,” or “might” (or other such language) be included or have a characteristic, that a specific component or feature is not required to be included or to have the characteristic. Such a component or feature may be optionally included in some embodiments, or it may be excluded.

Various embodiments of the present disclosure overcome the above technical challenges and difficulties and provide various technical improvements and advantages based on, for example, but not limited to, providing example methods, apparatuses, computer program products, integrated circuits, and processing systems for image analysis, such as for object identification as part of an artificial vision system.

Various embodiments of the present disclosure provide image macroscopic segmentation, which is a powerful way both of classifying objects basing on their macroscopic structure and to sensibly divide it into parts to be examined subsequently and stored as separate, though related concepts. Various embodiments of the present disclosure provide double-resolution representation (performing image analysis by segmenting an image into multiple segments and analyzing the image at low and high resolution), feedback-driven medial axis detector, and segment identification and centroid location.

Various embodiments of the present disclosure provide artificial neuron modules (V1, V2, and V4 cells or modules, as described below), which are inspired by the natural mammalian counterparts and have a refined structure which matches closely that of natural neurons. In this regard, embodiments of the present disclosure may be termed a neuromorphic vision system. Consequently, the artificial neurons of various embodiments implement more naturally the simple-to-complex cell spectrum (‘simple’ cells are those which respond to a given stimulus in a precise position, ‘complex’ cells are more tolerant to position, and there a continuum of responses in between), and can be extended to different types of stimuli.

Various embodiments of the present disclosure involve acquiring an image to be analyzed, blurring the acquired image to create a lower resolution image, performing one or more image analysis actions on the blurred image, storing the results of the image analysis actions performed on the blurred image as part of a neural fingerprint of the acquired image, performing one or more image analysis actions on one or more portions of the acquired image (i.e., the original, higher resolution image), and storing the results of the image analysis actions performed on the acquired image as part of the neural fingerprint of the acquired image. Various embodiments of the present disclosure provide a robust and efficient process for creating a neural fingerprint of an image which may be used for image identification using any suitable image identification process (which is not described herein).

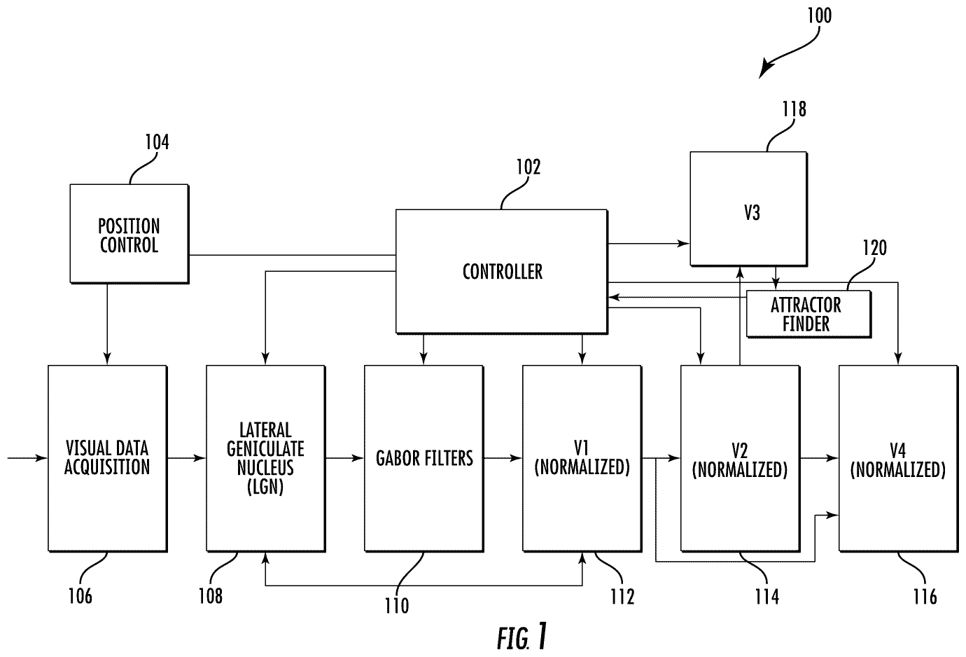

Referring now to FIG. 1, an example block diagram of an example system for image analysis is illustrated in accordance with an example embodiment of the present disclosure. In the illustrated embodiment, the example system 100 comprises a controller 102, a position control module 104, a visual data acquisition module 106, a lateral geniculate nucleus (LGN) module 108, a Gabor filters module 110, a V1 module 112, a V2 module, 114, a V4 module 116, a V3 module 118, and an attractor finder module 120.

High level descriptions of the components of the example system 100 are provided first, followed by a detailed description of an example method, and then followed by a more detailed description of the components of the example system 100. Some or all of the functionality described herein may be implemented as part of an integrated circuit (IC) to perform, for example, one or more functions described herein.

In various embodiments, the controller 102 coordinates the system, initiating the different phases of the analysis described herein. The controller or other processing elements described herein, such as the control circuitry, may include one or more processors, input/output circuitry, data storage media, communications circuitry, and/or other components configured to perform compute operations. In some embodiments, the data storage media may be configured to store information, data, content, applications, instructions, or the like, for enabling the processing elements described herein to carry out various functions. As such, in some embodiments, the controller or other processing elements described herein may be referred to as functional logic. The controller or other processing elements described herein may be embodied in a number of different ways, for example, in some embodiments, the controller or other processing elements described herein may include one or more processing devices configured to perform independently. Additionally or alternatively, in some embodiments, the controller or other processing elements described herein may include one or more processor(s) configured in tandem via a bus to enable independent execution of instructions, pipelining, and/or multithreading. The use of the terms “controller,” “processor,” “control circuitry,” and “processing circuitry” should be understood to include a single core processor, a multi-core processor, multiple processors internal to the processing elements described herein, and/or one or more remote or “cloud” processor(s) external to the processing elements described herein.

In an example embodiment, the controller or other processing elements described herein may be configured to execute instructions stored in the data storage media or otherwise accessible to the processor. Alternatively or additionally, the controller or other processing elements described herein in some embodiments is configured to execute hard-coded functionality. As such, whether configured by hardware or software methods, or by a combination thereof, the controller or other processing elements described herein represent an entity (e.g., physically embodied in circuitry) capable of performing operations according to an embodiment of the present disclosure while configured accordingly. Alternatively or additionally, as another example in some example embodiments, when the controller or other processing elements described herein is embodied as an executor of software instructions, the instructions specifically configure the controller or other processing elements described herein to perform the algorithms embodied in the specific operations described herein when such instructions are executed.

The use of the term “circuitry” as used herein with respect to components of the apparatus should therefore be understood to include particular hardware configured to perform the functions associated with the particular circuitry as described herein. The term “circuitry” should be understood broadly to include hardware and, in some embodiments, software for configuring the hardware. For example, in some embodiments, “circuitry” may include processing circuitry, storage media, network interfaces, input/output devices, and the like.

In various embodiments, the Position Control module 104 controls either the orientation of an orientable camera (not illustrated) or (if the image analyzed is part of a larger image) the portion of the larger image that should be analyzed. In either case, the Position Control module 104 controls which part of an image is outputted by the visual data acquisition module 106. In various embodiments, the image analysis starts with the centering of the visual data acquisition module 106 on the image to be analyzed. Since generally different ‘segments’ (or ‘blobs’) within the image need to be analyzed sequentially, the Position Control module 104 will instruct the visual data acquisition module 106 to recenter the image acquisition, as ordered in turn by the controller 102.

In various embodiments, the visual data acquisition module 106 acquires an image made of (at least) tens of thousands of pixels (e.g., a rectangle that is hundreds of pixels by hundreds of pixels, although other shapes are possible). In various embodiments, the image acquired by the visual data acquisition module 106 can come from a camera (possibly an oriented one) or be acquired differently (from another memory) as a static image. In various embodiments, scaling up is possible to any size, however scaling down makes less sense because each ‘neuron’ in the subsequent modules (described below) processes inputs from a “receptive field” whose area is in the hundreds of pixels. In various embodiments, the core of the visual data acquisition module 106 is a visual sensor which encodes the gray tone of each pixel with an analog voltage value. In various embodiments, these analog voltage values are fed to the Lateral Geniculate Nucleus module 108.

In various embodiments, the LGN module 108 processes the image provided by the visual data acquisition module 106, passing the image through a bank of filters with a center-surround excitatory/inhibitory connection distribution. This is equivalent to convolving the image with a kernel made of two concentric circles. The pixels falling into the inner circle (that of the excitatory connections) contribute to increase the cell's response, while those falling inside the outer corona (inhibitory connections) contribute to decrease it. This initial convolution blurs the image to a variable degree (preserving much detail in the hi-res state, or just the macroscopic structure in low-res). The V1-to-LGN feedback (indicated by the leftward arrow in FIG. 1 from the V1 module 112 to the LGN module 108) can alter the response of the cells depending on the border geometry detected at the V1 level, to evidence blobs and medial axes.

In various embodiments, the Gabor filters module 110 detects small linear pieces of the border of an object in the image by applying Gabor functions, or the like, with linearly oriented alternate excitatory and inhibitory connection areas. In various embodiments, the Gabor filters of the Gabor filters module 110 provides the input to the V1 module 112, which will detect linear borders on a larger scale and often with some tolerance with respect to the position of the border within the receptive field.

In various embodiments, the V1 module 112, the V2 module 114, and the V4 module 116 detect pieces of border (a border being define by luminosity contrast) with growing complexity. In various embodiments, the V1 module 112 detects small linear pieces of border with approximately constant orientation, the V2 module 114 aggregates the responses of the V1 module 112 to detect larger pieces of border with more complex shapes (e.g., angles), and the V4 module 116 detects even more complex shapes on proportionately larger receptive fields. In various embodiments, the cells in the V1 module 112, the V2 module 114, and the V4 module 116 are the same and are neuromorphically inspired. As in nature, the hierarchy is loose—a small fraction of the V1 module 112 output feeds directly the V4 module 116 (as illustrated in FIG. 1 by the direct arrow from V1 to V4), though the majority of V4 inputs are outputs from the V2 module 114.

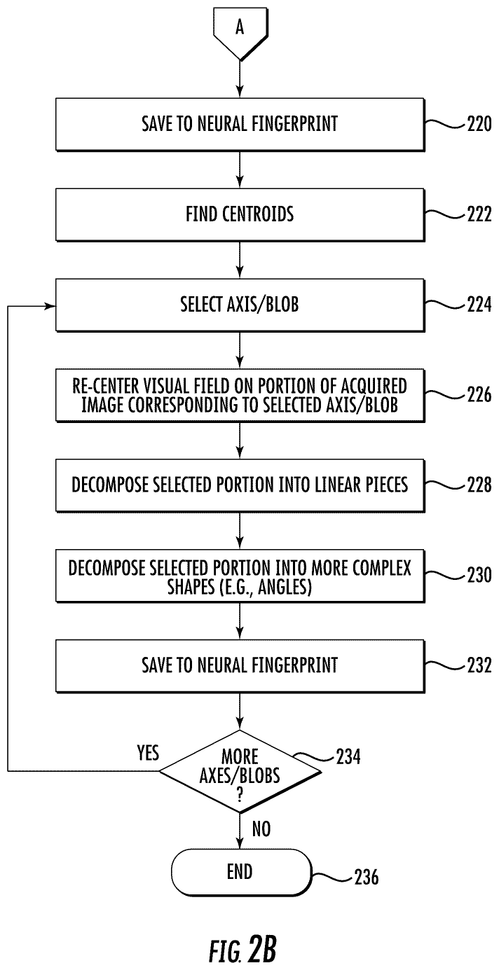

In various embodiments, the artificial cells in the V3 module 118 aggregate group of adjacent outputs from the V2 module 114 over variable areas. Each cell of the V3 module 118 receives inputs either from V2 cells sensitive to (approximately) the same orientation to detect linear medial axes, or from V2 cells in the same spot but sensitive to a blend of different orientations for small, roundish spots (referred to herein as blobs) such as those detected in the middle of round shapes (e.g., see FIG. 3, segment 310). In various embodiments, the structure of each cell of the V3 module 118 is of the center-surround type (excitatory connections in the center, inhibitory in the surrounding) where the algebraic sum of the inputs passes through a thresholding function.

In various embodiments, the Attractor Finder module 120 locates groups of adjacent, strongly responding V3 cells, representing a significant segment of the low-resolution image. Each group is represented by its centroid, whose approximate coordinates are provided to the controller 102.

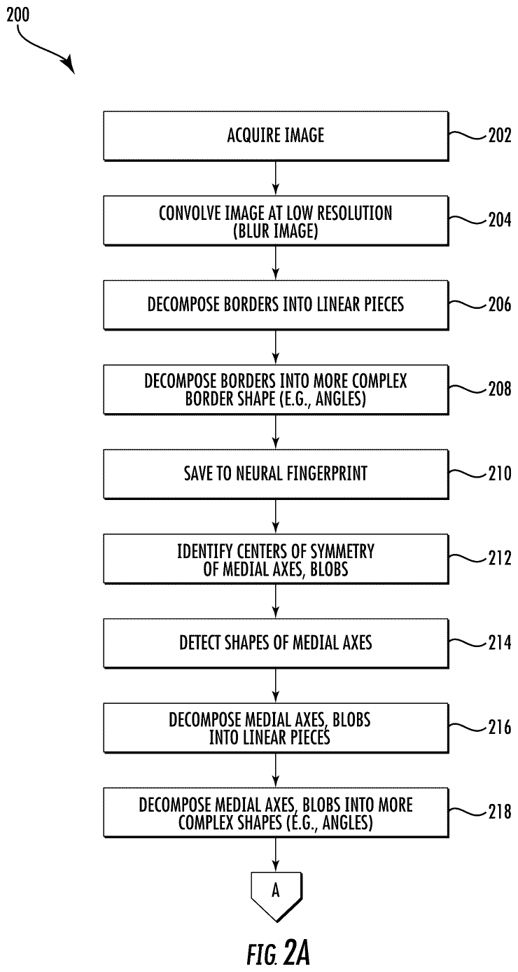

Reference will now be made to FIGS. 2A and 2B which provide a flowchart illustrating example steps, processes, procedures, and/or operations in accordance with various embodiments of the present disclosure. Various methods described herein, including, for example, example methods as shown in FIGS. 2A AND 2B, may provide various technical benefits and improvements. It is noted that each block of the flowchart, and combinations of blocks in the flowchart, may be implemented by various means such as hardware, firmware, circuitry and/or other devices associated with execution of software including one or more computer program instructions. For example, one or more of the procedures described in FIGS. 2A AND 2B may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

Having described example systems, apparatuses, computing environments, and user interfaces associated with embodiments of the present disclosure, example flowcharts including various operations performed by the circuits, apparatuses, systems, and/or devices described herein will now be discussed. It should be appreciated that each of the flowcharts depicts an example process that may be performed by one or more of the circuits, apparatuses, systems, and/or devices described herein, for example utilizing one or more of the components thereof. The blocks indicating operations of each process may be arranged in any of a number of ways, as depicted and described herein. In some such embodiments, one or more blocks of any of the processes described herein occur concurrently rather than sequentially. In some such embodiments, one or more blocks of any of the processes described herein occur in-between one or more blocks of another process, before one or more blocks of another process, and/or otherwise operates as a sub-process of a second process. Additionally or alternatively, any of the processes may include some or all of the steps described and/or depicted, including one or more optional operational blocks in some embodiments. In regard to the below flowchart(s), one or more of the depicted blocks may be optional in some, or all, embodiments of the disclosure. Optional blocks are depicted with broken (or “dashed”) lines. Similarly, it should be appreciated that one or more of the operations of each flowchart may be combinable, replaceable, re-ordered, and/or otherwise altered as described herein.

Referring now to FIGS. 2A AND 2B, an example flow diagram illustrating an example method 200 for image analysis in accordance with some embodiments of the present disclosure is illustrated. In some embodiments, the example method 200 may be implemented by an example system described herein, including, but not limited to, the example system 100 described above in connection with FIG. 1.

In the example method shown in FIGS. 2A AND 2B, the example method 200 starts at step/operation 202. At step/operation 202, one or more components of a system (such as, but not limited to, the visual data acquisition module 106 described above in connection with FIG. 1) acquires an image to be analyzed. In various embodiments, the image acquired by the visual data acquisition module 106 can come from a camera or be acquired from another memory as a static image.

At step/operation 204, one or more components of a system (such as, but not limited to, the LGN module 108 described above in connection with FIG. 1) convolves the image at a low resolution to obtain a blurred image. The left image 300 of FIG. 3 shows an example of such a blurred image of a human.

At step/operation 206, one or more components of a system (such as, but not limited to, the V1 module 112 described above in connection with FIG. 1) decomposes the borders of the blurred image into linear segments.

At step/operation 208, one or more components of a system (such as, but not limited to, the V2 module 114 and the V4 module 116 described above in connection with FIG. 1 operating sequentially) decomposes the borders of the blurred image into more complex segments, such as angles.

At step/operation 210, one or more components of a system (such as, but not limited to, the controller 102 described above in connection with FIG. 1) stores the output of V4 from step/operation 206 and step/operation 208 in memory (not illustrated) as part of the “neural fingerprint” of the image. It is the neural fingerprint of the image (when completed as described further below) that is used to identify an object in the acquired image using any suitable process.

At step/operation 212, one or more components of a system (such as, but not limited to, the V1 module 112 to LGN module 108 feedback loop described above in connection with FIG. 1) varies the gain of the LGN cells according to the geometry, to evidence the centers of symmetries of medial axes and less differentiated shapes (called “blobs”). The right image 302 of FIG. 3 shows examples of such blobs 310 and axes 320-360.

At step/operation 214, one or more components of a system (such as, but not limited to, the V1 module 112 described above in connection with FIG. 1) detects the shapes of the medial axes, which provides an important cue to shape description and recognition.

At step/operation 216, one or more components of a system (such as, but not limited to, the V2 module 114 and the V4 module 116 described above in connection with FIG. 1) decomposes the medial axes and blobs of the blurred image into linear segments.

At step/operation 218, one or more components of a system (such as, but not limited to, the V2 module 114 and the V4 module 116 described above in connection with FIG. 1 operating sequentially) decomposes the medial axes and blobs of the blurred image into more complex segments, such as angles.

At step/operation 220, one or more components of a system (such as, but not limited to, the controller 102 described above in connection with FIG. 1) stores the output of V4 from step/operation 218 in memory as part of the neural fingerprint of the image.

In various embodiments, once the gross structure of the image has been defined in terms of medial axes (or medial blobs, in case of approximate central symmetries), cells in the V3 block 118 detect the medial axes and medial blobs (in various embodiments, there are V3 cells capable of detecting medial axes within approximately a given orientation and other V3 cells capable of detecting unoriented blobs). Each medial axis or blob makes a group of V3 cells react. According to the example of FIG. 3, a group of V3 cells will react to unoriented blob 310, while another will reach to the approximately vertical medial axis 340. At step/operation 222, one or more components of a system (such as, but not limited to, the attractor finder module 120 described above in connection with FIG. 1) then finds the centroids of the different segments of the image.

At step/operation 224, one or more components of a system (such as, but not limited to, the controller 102 described above in connection with FIG. 1) selects one of the axes or blobs for high resolution analysis.

At step/operation 226, one or more components of a system (such as, but not limited to, the visual data acquisition module 106 as commanded by the controller 102 described above in connection with FIG. 1), the visual field is re-centered on the selected axis or blob.

At steps/operations 228, 230, and 232, a high-resolution analysis is performed of the selected axis or blob. At step/operation 228, one or more components of a system (such as, but not limited to, the V1 module 112 described above in connection with FIG. 1) decomposes the selected section of the original, high-resolution image into linear segments.

At step/operation 230, one or more components of a system (such as, but not limited to, the V2 module 114 and the V4 module 116 described above in connection with FIG. 1 operating sequentially) decomposes the selected section of the original, high-resolution image into more complex segments, such as angles.

At step/operation 232, one or more components of a system (such as, but not limited to, the controller 102 described above in connection with FIG. 1) stores the output of V4 from step/operation 228 and step/operation 230 in memory as part of the neural fingerprint of the image.

At step/operation 234, one or more components of a system (such as, but not limited to, the controller 102 described above in connection with FIG. 1) determines if all of the identified axes and blobs have been analyzed at high resolution. If not, the method returns to step/operation 224 and selects the next axis or blob. Steps/operations 224-234 are repeated until all of the identified axes and blobs have been analyzed at high resolution. The method 200 ends at step/operation 236.

In various embodiments, the workflow may be terminated earlier if no detailed high-resolution analysis is needed. For example, to detect a tree (e.g., as a potential obstacle on a pathway), steps/operations 202-220 may be enough. Once the tree has been identified through its macroscopic structure (a green mass above and a more or less straight and vertical brown mass below), further examination may not be required.

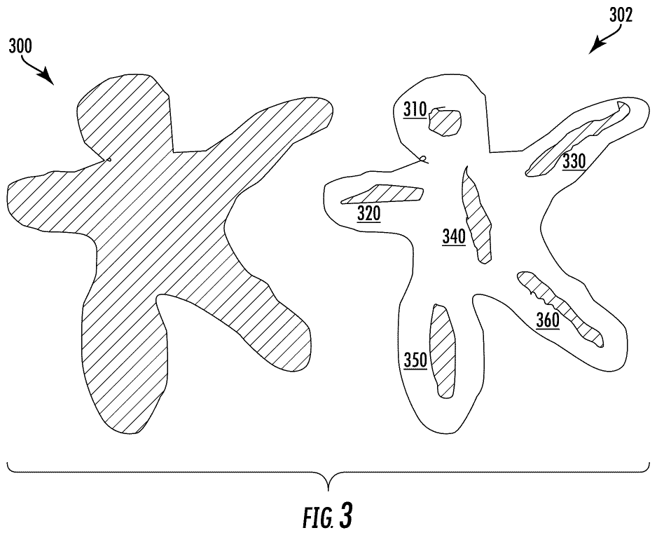

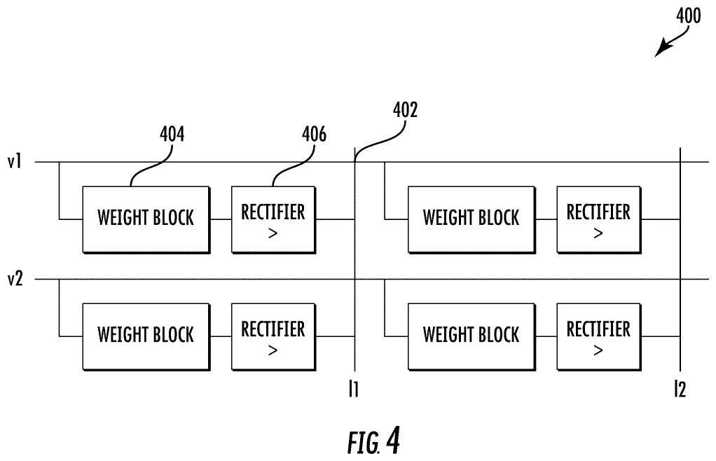

Referring now to FIG. 4 which illustrates an example unidirectional (analog) network for creating a weighted input sum and FIGS. 5-9 in which various aspects of feedback networks of an example system for image analysis are illustrated in accordance with example embodiments of the present disclosure. In various embodiments, the primary feedback network is from the V1 module 112 to the LGN module 108. In various embodiments, crossbar structures can be useful to route analog inputs to their pathway. The connections at the crossings of such crossbar structures can be either hard-defined (lithographed metal) only where needed, or present everywhere and programmable (e.g., they can be set to have broadly variable resistances or conductances, like the so-called phase change memories (PCM)). Such crossbar structures have been used, for example, in so-called in-memory computing (IMC) systems. In various embodiments with such crossbar structures, input voltages produce currents depending on how they combine through the conductances.

FIG. 4 illustrates an example generic unidirectional crossbar circuit 400. The crossbar circuit 400 comprises two voltage input lines v1, v2 and two current output lines I1, I2. At each crossing 402 of the voltage lines and the current lines there is a weight block 404 and a rectifier 406. In various embodiments, the rectifier 406 is needed in any crossbar to avoid the well-known sneak path effect (the arrows in the rectifier block indicates the allowed current's conventional verse). In various embodiments, the rectifiers can be made in any known way, including diodes and transistors. In the latter case, an additional «column» is needed to keep the gate of the transistor high, which can be used to switch the corresponding crossing on and off. In the embodiments of FIGS. 5-8, where not explicitly sketched with an activation line, the rectifier can be of either type.

In various embodiments, the weight block can be modeled as an impedance which modulates the effect of input v on current I−«weighs» input v. The current contribution of voltage Vn at, say, the j-th crossing is I=Vn/Rj. In various embodiments, the input Vn is then “weighed” by coefficient 1/Rj, the reciprocal of the j-th weight block's resistance. In various embodiments, Rj will generally take up either a quite high value (crossing approximately ‘disconnected,’ resulting in negligible I) or a relatively low value. In various embodiments, the crossbar circuit can be hard-defined and unchangeable (e.g., one-time programmable during fabrication (a resistor, a metallic connection, or the absence of any connection when the crossbar is to be left open)) or reprogrammable (e.g., a memristor or a PCM).

FIG. 5 illustrates an example crossbar circuit 500 for an asynchronous feedback scheme. The crossbar circuit 500 comprises a plurality of lower-level cells 510 (two are illustrated), each having a corresponding feedforward line (“FFWD LINE”) and feedback line (“FB LINE”). As with FIG. 4, a weight block 504 and rectifier 506 (for the FFWD lines) or 508 (for the FB lines) at each crossing. Notice that the rectification is inverse in the feedback column connections. Each crossbar connection 502 connects either a feedforward column (“FFWD COLUMN”), an overlapping feedback column (“OV FB COLUMN”), or a non-overlapping feedback column (“NON-OV FB COLUMN”) to an upper-layer cell 512.

In various embodiments, the output and feedback run continuously across distinct lines. In various embodiments, the signals enabling the feedback columns, as well as that enabling the feedforward column, can be set high at the beginning of the circuit operation and there is no need for synchronized enabling/disabling afterwards.

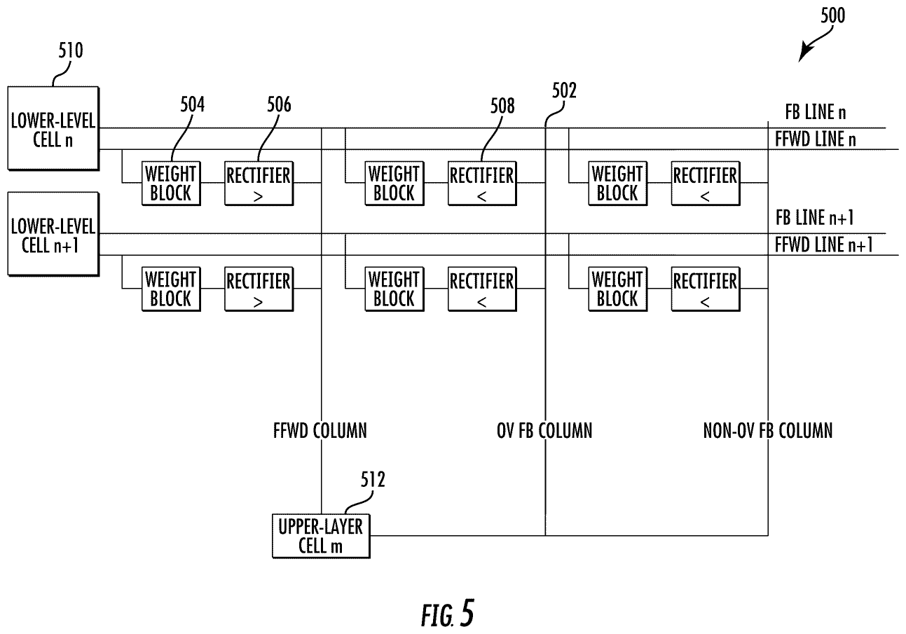

FIG. 6 illustrates an example crossbar circuit 600 for a synchronous feedback scheme. The crossbar circuit 600 comprises a plurality of lower-level cells 610 (two are illustrated), each having a corresponding feedforward line (“FFWD LINE”) and feedback line (“FB LINE”). As with FIG. 5, a weight block 604 and rectifier 606 (for the FFWD lines) or 608 (for the FB lines) at each crossing 602. Notice that the rectification is inverse in the feedback column connections. Each crossbar connection 602 connects either a feedforward column (“FFWD COLUMN”), an OV feedback column (“OV FB COLUMN”), or a non-OV feedback column (“NON-OV FB COLUMN”) to an upper-layer cell 612. Some of the rectifiers are connected to activation lines 614.

In various embodiments, FB is high when feedback is to be provided. In the illustrated embodiment, both upper-layer cells 612 and lower-level cells 610 receive FB, but this may not be necessary in all implementations. For example, in some embodiments the upper-level cell can be made in such a way that, when the upper-level cell does not receive any input, the upper-level cell simply keeps its output signals unchanged. In this way, the upper-level cell does not need to know the state of FB. When FB is low, the upper-level cell will receive input and change its output accordingly. When FB is high, the input line will be kept in a high-impedance state or similar, so that the upper-level cell will not modify its output which, in turn, will be fed to the lower-level cells as feedback. In this way, the upper-level cell does not need to know the state of the FB signal directly. Conversely, in other embodiments, the upper-level cell is fed FB: when FB is low (no feedback is being provided) the upper-level cell is reactive to its inputs and when FB is high the upper-level cell freezes its output state, which is fed to the lower layer. In various embodiments, lower-level cells whose receptive fields (RFs) overlap with the corresponding upper-layer cell provide direct input to the upper-layer cell, while non-overlapping cells just receive feedback and do not supply any feedforward input. In various embodiments, the upper-layer cell receives input from cells in the lower layer whose receptive field overlaps with its own receptive field, at least partly. However, the upper-layer cell distributes its feedback to a broader region of the lower layer, including cells whose receptive field does not overlap with its own (and from which, therefore the upper-layer cell does not receive input). For this reason, in various embodiments the connections (PCMs or other) in the FFWD and OV-FB columns must be set in the same states. In various embodiments, the lower-level cells feature distinct FFWD output and FB input lines.

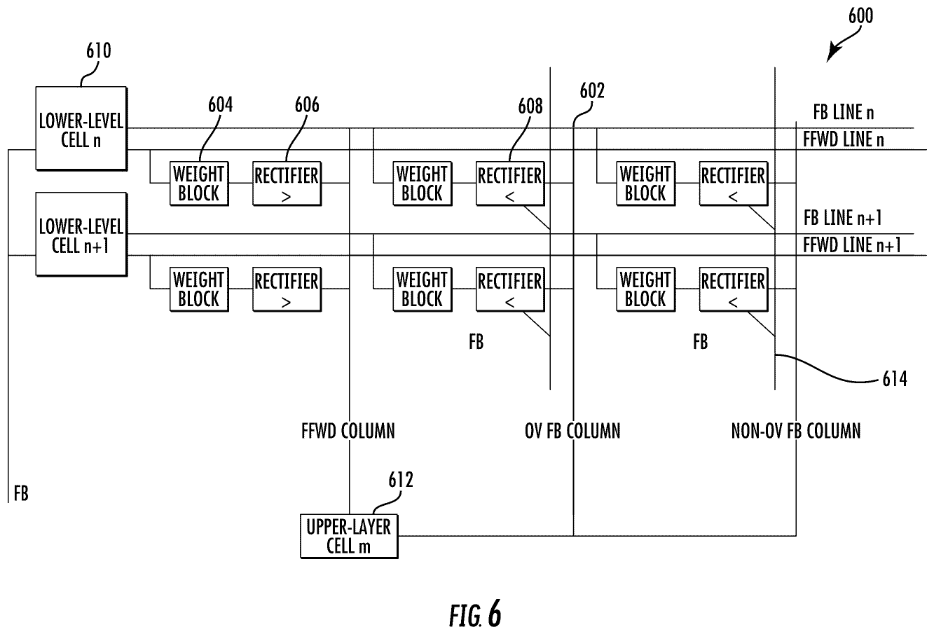

FIG. 7 illustrates another example crossbar circuit 700 for a synchronous feedback scheme. The crossbar circuit 700 comprises a plurality of lower-level cells 710 (two are illustrated), each having a corresponding feedback line (“FB LINE”). In various embodiments, the FB LINE also functions as a FFWD LINE, since FB and FFWD processing does not occur at the same time. As with FIG. 5, a weight block 704 and rectifier 706 or 708 at each crossing 702. Each crossbar connection 702 connects either a feedforward column (“FFWD COLUMN”), an OV feedback column (“OV FB COLUMN”), or a non-OV feedback column (“NON-OV FB COLUMN”) to an upper-layer cell 712. Some of the rectifiers are connected to activation lines 714. In various embodiments, the output line of lower-level cells 710 becomes the feedback line when FB is on, thus halving the wiring required for lines.

In various embodiments, the FB signal received by lower-level cells 710 is necessary to switch the pathway of cells. This is seen in the sub-circuit 720 of FIG. 7 in which the lower-level cell 710 is connected to an analog latch 722 and a switch 724 switches the line between connecting to the output of the lower-level cell 710 and to the feedback of the lower-level cell 710.

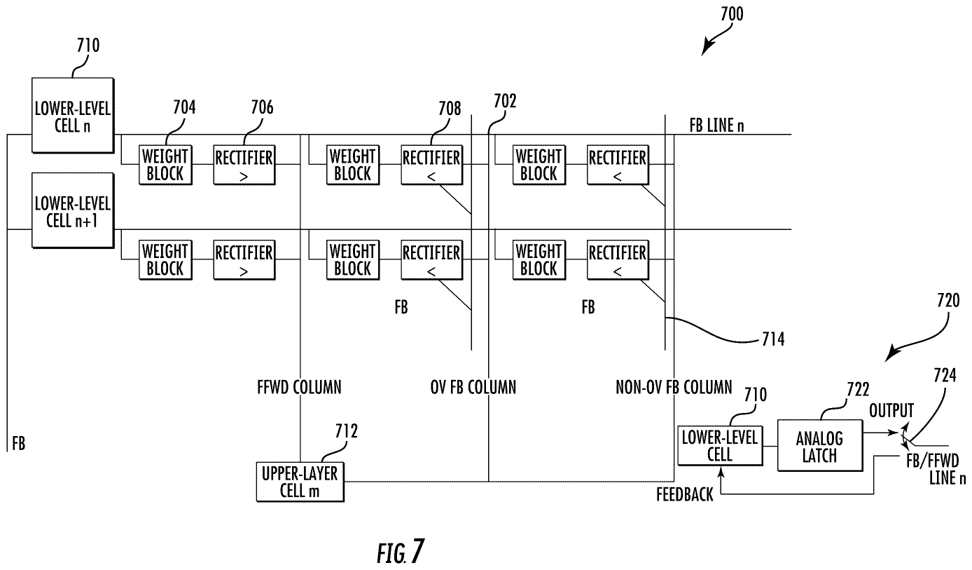

FIG. 8 illustrates another example crossbar circuit 800 for a synchronous feedback scheme. The crossbar circuit 800 comprises a plurality of lower-level cells 810 (two are illustrated), each having a corresponding feedback line (“FB LINE”). In various embodiments, the FB LINE also functions as a FFWD LINE, since FB and FFWD processing does not occur at the same time. As with FIG. 5, a weight block 804 and rectifier 806 or 808 at each crossing 802. Each crossbar connection 802 connects a feedforward/overlapping feedback to an upper-layer cell 812. Some of the rectifiers are connected to activation lines 814. In various embodiments, the embodiment of FIG. 8 is suitable for a synchronous feedback scheme only because the feedforward and overlapped-feedback signals share the same line.

In various embodiments, during the feedback phase (represented here as feedback FB signal low (FB bar)), the output cell (i.e., lower-level cell n) supplies its feedback signal to its overlapping lower-level cells (through the left-hand column) and to the non-overlapping cells (right-hand column) in which the highly conductive PCM correspond to the connected, non-overlapping lower-level cells.

In this embodiment, the FB-controlled switching is needed on the upper-layer side as well. This is seen in the sub-circuit 820 of FIG. 8 in which the upper-layer cell 812 is connected to a switch 826 that switches the FFWD OV FB line between the input and the output of the upper-layer cell 812 and to a switch 824 that enables feedback to the non-overlapping lower-layer cells.

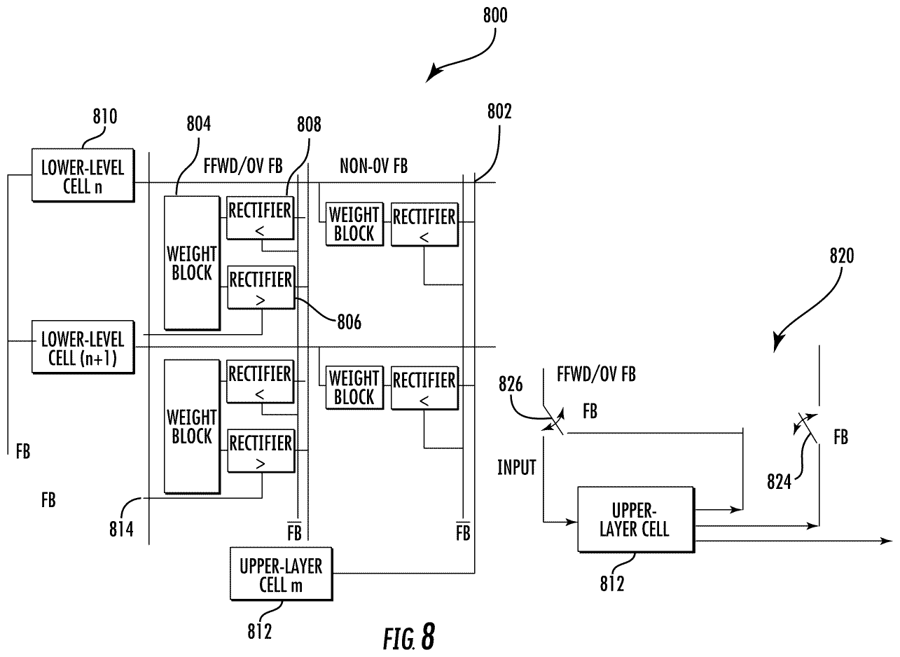

FIGS. 9A and 9B illustrates example circuits for the processing of feedback signals (encoded by current intensities) in the lower-level cell, according to the type of scheme adopted (synchronous or asynchronous). FIG. 9A illustrates an example circuit 900 for the processing of feedback signals in the lower-level cell for an asynchronous feedback scheme. FIG. 9B illustrates an example circuit 920 for the processing of feedback signals in the lower-level cell for a synchronous feedback scheme.

The example circuit 900 of FIG. 9A comprises a buffer 902 and a resistor R. The feedback line is connected to the input of the buffer 902 and the resistor R connects the input of the buffer 902 to ground. The output of the buffer 902 is connected to the processing block 904. In various embodiments, the processing block 904 ‘decides’ how to react to the feedback signal. For example, LGN cells decrease (increase) their gain according to the amount of overlapping (non-overlapping) feedback they receive. In those cells, the output of the buffer acts on the cell response to change the amplification. In various embodiments, whatever the effect of feedback on the cell operation (and it can be any), it is decided in the processing block. In the example circuit 900, the current is turned into a voltage which is read by the processing part of the lower-level cell.

The example circuit 920 of FIG. 9B comprises a buffer 902, a resistor R (optional) and a capacitor C in parallel, and a switch 906. The feedback line is connected to the input of the buffer 902 and the R-C circuit connects the input of the buffer 902 to ground. The output of the buffer 902 is connected to the processing block 904 via the switch 906. In the example circuit 920, the current signal is integrated during the FB low-period to be read by the processing part of the lower-level cell during the FB high-period.

In various embodiments, feedback can produce a continuous current or pulsed current bursts, even a single impulse in a synchronous scheme. In various embodiments, this allows reduced power consumption and heating, especially with numerous connections. In various embodiments, pulses can be output by artificial neuromorphic cells of the spiking type, thereby mimicking the pulsed behavior of natural neurons.

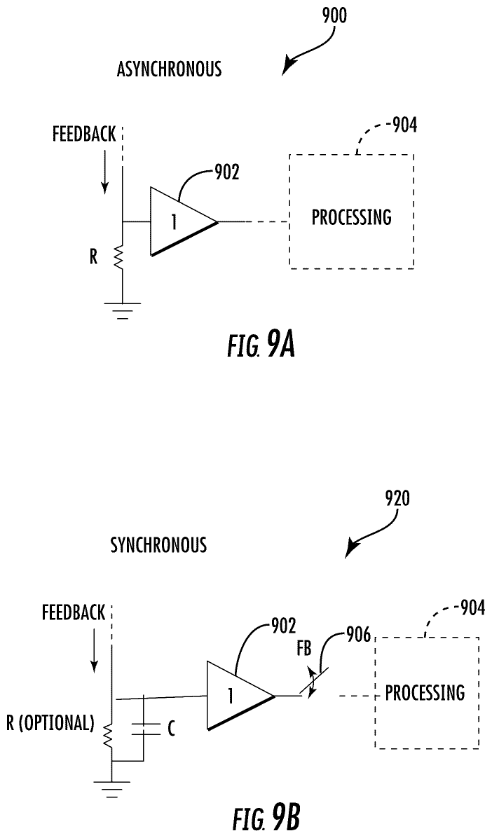

Referring now to FIGS. 10-14, various aspects of lateral connections of an example system for image analysis are illustrated in accordance with example embodiments of the present disclosure. In various embodiments, the primary lateral connections are from the V1 module 112 to the V2 module 112 and the V4 module 116 and from the V2 module 112 to the V4 module 116.

In various embodiments, local normalization is applied to the artificial neurons (i.e., the neuron cells in the V1, V2, and V4 modules). In various embodiments, normalization relates to comparing the activity of an artificial neuron with that of its “neighborhood.” In various embodiments, such normalization may include: amplifying to saturation the response of the maximally firing neuron, and dampening (down to zero) the response of its neighbors (which is termed max-pooling); amplifying the highest x % percentile of response and dampening the others; and/or amplifying the neurons firing at least with ka intensity, where k>1 and a is the neighborhood average. In various embodiments, all of these approaches typically involve applying a threshold, under which all the artificial neurons are dampened. In various embodiments, normalization improves the signal to noise ratio and makes the neural representation of stimuli more compact (i.e., “sparse” neural code).

In principle, point-to-point connections could be used between an artificial neuron and all its neighbors. This is how it works in the brain, but it is not feasible in a planar silicon structure. Rather, in various embodiments, each artificial neuron receives the maximum (or reference value) propagated by its neighbors and compares this value to its own value inside a dedicated structure. If the receiving neuron's value is greater, the receiving neuron's value will become the new reference value and the normalization will be done accordingly. Else, the receiving neuron's response will be dampened. In various embodiments, the reference value is accompanied by a “distance signal” which is updated at each pass. This distance signal indicates how far away is the artificial neuron whose value provided the received reference value. When the receiving neuron is too far from the neuron which originated the reference value, the received value is no longer valid as a reference because it has trespassed the boundary of the neighborhood.

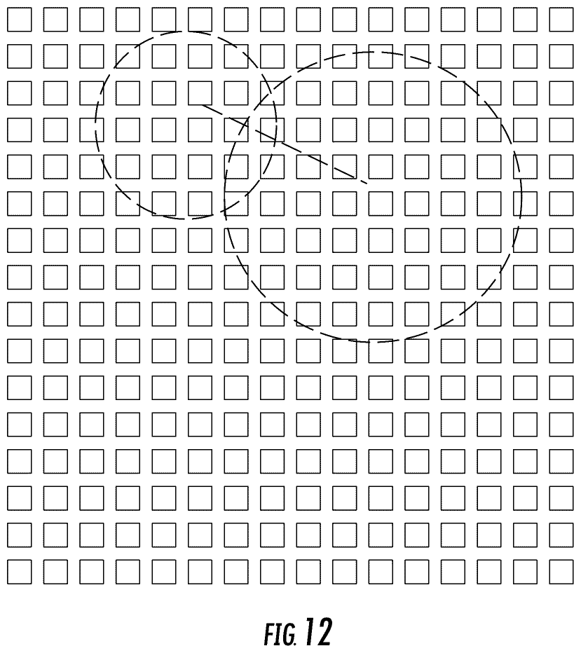

FIG. 10 illustrates a grid or array of individual neuron cells. Each neuron cell 1000 comprises a neural block 1002, an update block 1004, and a select block 1006. The functionality of these cell block is described further below. The connections among the individual neuron cells is not shown in FIG. 10 but illustrated in FIG. 13. In various embodiments, each of the V1, V2, and V4 modules will comprise a very large number of individual neuron cells. For example, given a m×n input pixel grid (and an equal number of LGN cells), the number of V1 cells should not be smaller. In fact, a larger number is typically preferable. In one specific example, a grid of V1 cells is 3m×3n, containing nine times more neurons than the number of input pixels. In various embodiments, the V2 and V4 layers would contain as many cells as V1. However, any suitable number of cells can be used.

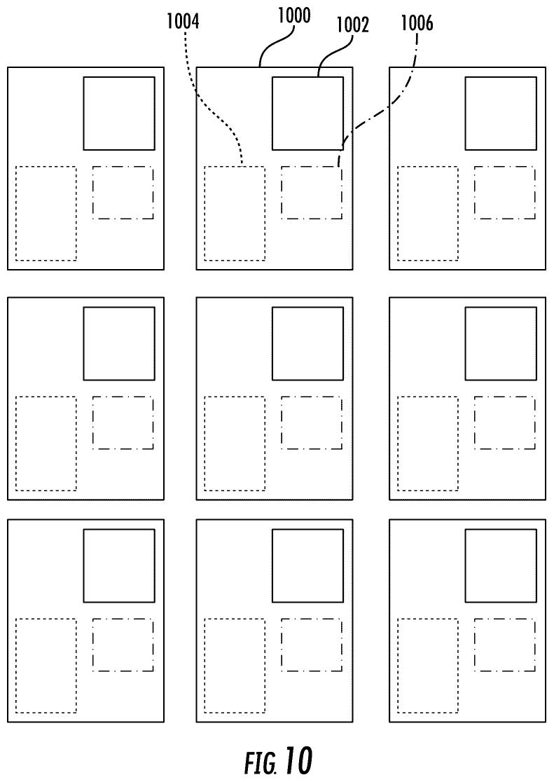

FIG. 11 illustrates one example of the signal flow into, out of, and within an individual neuron cell of embodiments of the present disclosure. The embodiment illustrated in FIG. 11 may be termed the “max calculation” embodiment. In various embodiments, the neural block 1002 performs computations based on inputs not shown. The scaled local output (UnnormOut) is independent of the neighboring activity. In various embodiments, the current maximum (CurMax) values propagate from the neighborhood along the four directions. That is, each individual neuron cell (except those on an edge) receives a CurMax value from the neuron cell to its left (CurMax_{LEFTin}). its right (CurMax_{RIGHTin}), above (CurMax_{UPin}), and below (CurMax_{DOWNin}), and each individual neuron cell (except those on an edge) sends a CurMax value to the neuron cell to its left (CurMax_{LEFTout}). its right (CurMax_{RIGHTout}), above (CurMax_{UPout}), and below (CurMax_{DOWNout}).

In various embodiments, each CurMax value is accompanied by a Prop signal which decreases progressively as it is sent from neuron cell to neuron cell along while its associated CurMax propagates. That is, each individual neuron cell (except those on an edge) receives a Prop value from the neuron cell to its left (Prop_{LEFTin}). its right (Prop_{RIGHTin}), above (Prop_{UPin}), and below (Prop_{DOWNin}), and each individual neuron cell (except those on an edge) sends a Prop value to the neuron cell to its left (Prop_{LEFTout}). its right (Prop_{RIGHTout}), above (Prop_{UPout}), and below (Prop_{DOWNout}). In various embodiments, when Prop falls below a threshold, the associated CurMax value is no longer propagated because the neighboring boundaries have been trespassed.

In various embodiments, the Update block 1004 decreases the Prop signals by some amount, nullifying them (and the corresponding CurMax value) when the Prop value goes below a predefined threshold. The updated CurMax value (CurMax_{updt}) and Prop value (Prop_{updt}) are output to the Select block 1006.

In various embodiments, the Select block 1006 compares the four CurMax values output by the Update block 1004 with UnnormOut. Some CurMax values could be 0 if the corresponding Prop is 0. In various embodiments, the maximum of the five values (four CurMax and UnnormOut) is the CurMax_{OUT}, which is propagated to the cells around, becoming the CurMax_{IN} signals for other cells around. In various embodiments, the Select block 1006 also outputs the Prop_{OUT} signal which accompanies CurMax_{OUT}. If CurMax_{OUT} has been found among one of the CurMax_{IN} signals, Prop_{OUT} is the corresponding Prop_{IN}. Otherwise, the maximum found is UnnormOut which means that the current neuron cell has the highest activity in the neighborhood, in which case Prop_{OUT} if given the maximum value possible. For example, the maximum value for Prop_{OUT} may be 1, for a maximum normalized distance, to be decreased to 0 within a radius of n cells around. In various embodiments, the cell output from the neural block 1002 is the true normalized output of the cell, and it is passed to the upper layers and/or used to provide feedback to the lower layer. In V4, the cell output can become part of the neural fingerprint of the image. If intra-layer normalization is present, say, in V1 (as is likely the case), then the block 112 to block 114 connection and the block 112 to block 116 connection in FIG. 1 carry the cell output signals, which have been normalized.

In various embodiments, the duration of the first phase (calculation of the local maximum) must last long enough to allow the circuit to reach stability. Once the local maximum has been set, the NormEnable signal, which is distributed like a clock signal, freezes the CurMax_{OUT} calculated and allows the cell to use CurMax_{OUT} for normalization. In various embodiments, to prevent instability, calculation of local maxima and normalization cannot occur at the same time since the maximum is calculated on the ‘raw’ values (still unnormalized) and subsequently used for normalization. In various embodiments, if needed for circuital reasons, the phases can be repeated alternately.

In various embodiments, both the Prop signal and the UnnormOut signal need to keep within a proper range for correct circuit operation. The Prop signal is an indicator of ‘how far’ a local maximum found somewhere has been propagated and serves to restrict its effect to a defined neighborhood. The UnnormOut, as the name suggests, is proportional to the local output of the cell (the output obtained by the activity of the cell only before it is normalized by the local maximum). Some pre-scaling may be required to keep it within the correct range, depending on the output range of the cell.

In another example embodiment which may be termed the “global max” or “MaxPooling” embodiment (not illustrated), each individual neuron cell calculates the global maximum over all the cells in the layer, an operation known in artificial intelligence (AI) as MaxPooling. This global maximum value is sent to all surrounding neuron cells.

In the embodiment illustrated in FIG. 11, each neuron cell communicates with four other cells: left, right, above, and below. In various other embodiments (not illustrated), each neuron cell communicates with eight other cells: left, right, above, below, diagonally up and left, diagonally down and left, diagonally up and right, and diagonally down and right.

In various embodiments, the neighborhood of each neuron cell is square-shaped, for example, each neuron cell is in the middle of its own 3×3 matrix of neuron cells (except for neuron cells on the edges).

In various other embodiments, a circular neighborhood for each neuron cell can be approximated. For example, the attenuation of the Prop signal can be made larger (e.g., by about sqrt(2)) along the diagonal or the diagonal terms in the average can be multiplied by a coefficient b<a (e.g., diminished by about sqrt(2)).

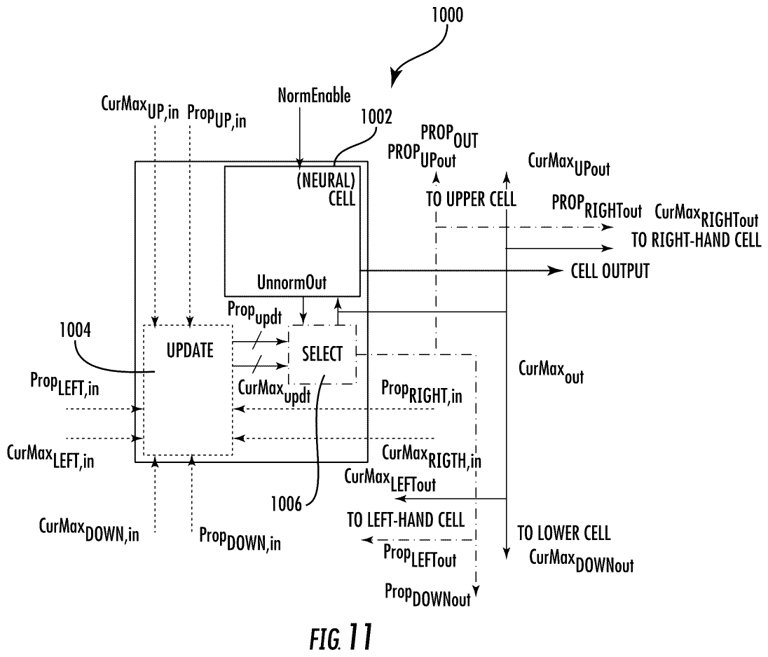

FIG. 12 represents one example of a logical (NOT physical) layout of the neuron cells in the lower layer in a 2D grid. Each “pixel” in the grid (i.e., each square in FIG. 12) represents the output of a cell in the lower layer. In the upper layer, each cell will be fed by inputs from a subset of the lower layer enclosed within a circle of given (variable) radius, representing the receptive field (RF) of the upper cell (i.e., the dashed circles of FIG. 12). In various other embodiments, neuron cells within a neighborhood will be laterally connected (i.e., the dashed line of FIG. 12).

However, if input crossbars are used, as described above, the physical layout must turn differently from the logical layout. In various embodiments, when using a unique crossbar the cells should be implemented in order, following a pathway in the plane. For example, starting in one corner, going down each column of cells until the bottom is reached, then moving upward on the next adjacent column.

In various embodiments, each cell will need to connect with the cells in its (logical) neighborhood, which, in the physical crossbar-based neighborhood, will be partly near, partly far. FIG. 13 illustrates such an example circuit. The example circuit 1300 of FIG. 13 comprises a crossbar 1302 (similar to those described above) connected to a plurality of neuron cells 1304 (three are shown). The neuron cells 1304 have a connection 1306 therebetween. Notice that each neuron cell 1304 both feeds and is fed by other cells, i.e., the connections are directional. In this way, the number of connections grows rapidly and their length can become remarkable.

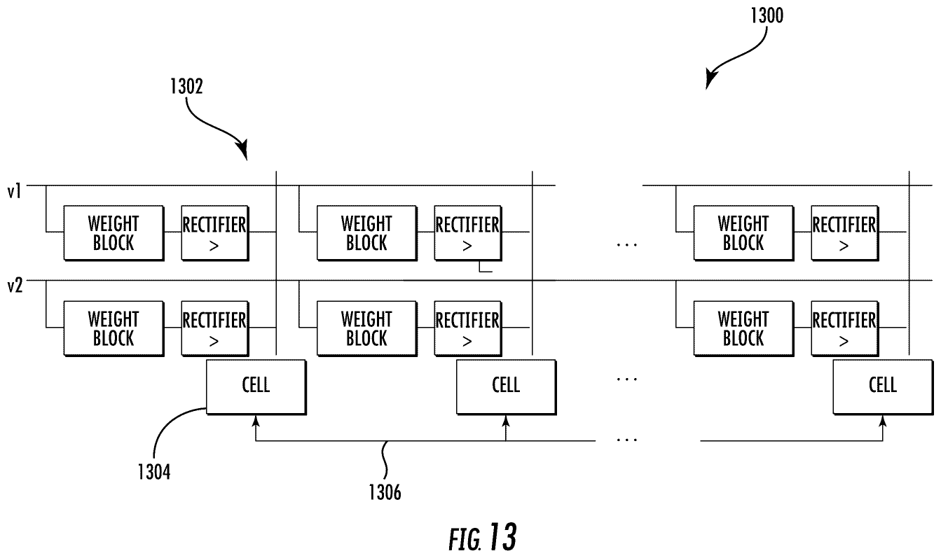

FIG. 14 illustrates a possible solution. A first metal layer comprises output lines 1406 and lateral connections 1408. The cell connection lines 1410 connect the cells to each other through the parallel lines 1412 of a second metal layer using interlayer connections (vias, PCMs, etc.) represented by dots 1414. However, the connections in both layers can become very long, and the propagation delays can grow accordingly. To solve this problem, one can consider extending voltage and current buffers to lines 1412.

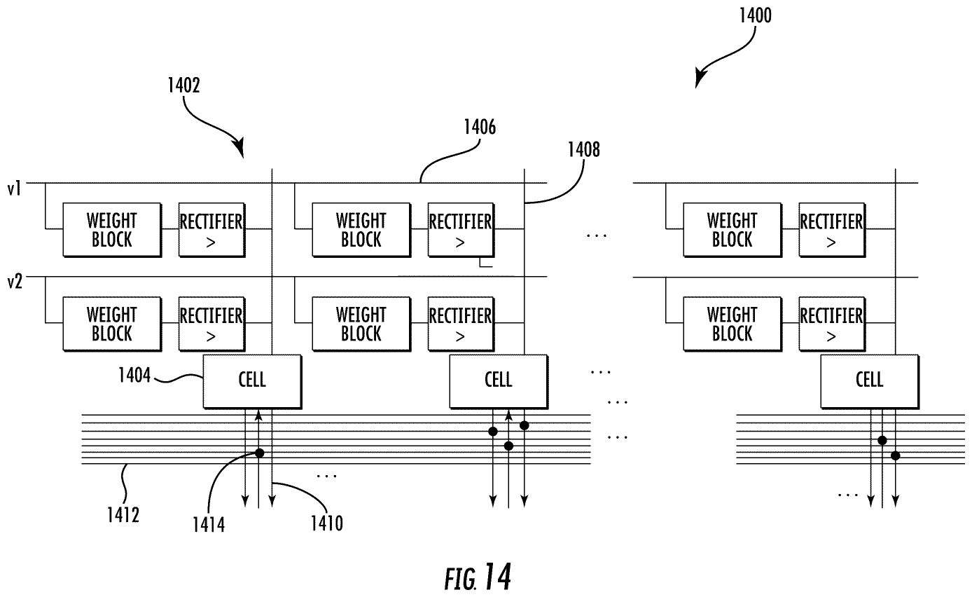

Referring now to FIGS. 15-21, various aspects of variable-resolution cells for attentive/pre-attentive processing of an example system for image analysis are illustrated in accordance with example embodiments of the present disclosure. In various embodiments, such variable-resolution cells for attentive/pre-attentive processing are in the LGN module 108.

At an early stage of a mammalian visual processing system, there are cells which respond nonlinearly to contrast. The response to contrast can be expressed as:

$$R ( C ) = \frac{{R}_{max} * {C}^{n}}{{C}^{n} + {C}_{50}^{n}} + b ;$$

where b is the minimal contrast response, C₅₀ the response to half-scale contrast, Rₘₐₓ is a coefficient (i.e., a gain), and C is defined using the Michelson contrast formula which is:

$$C = \frac{{I}_{max} - {I}_{min}}{{I}_{max} + {I}_{min}}$$

in which I is the current (which analogous to the luminosity). Mathematically, when the contrast is maximum (c=1), the formula above yields another response value, which accounts for Rmax as well as b. Interpolation yields n around 2. In addition to responding to contrast, embodiments of the present disclosure have the capability of analyzing an image at both a low and a high resolution.

In various embodiments, the cells in the LGN module 108 have center/surround-organized receptive fields which enlarge in the low-res state. This is illustrated in FIG. 15 in which the excitatory inputs are in the center and are indicated by (+) and the inhibitory inputs surround the excitatory inputs and are indicated by (−). In various embodiments, the excitatory (+) and inhibitory (−) inputs are summed algebraically, which is indicated by the enlarged dashed line circles on the right of FIG. 15.

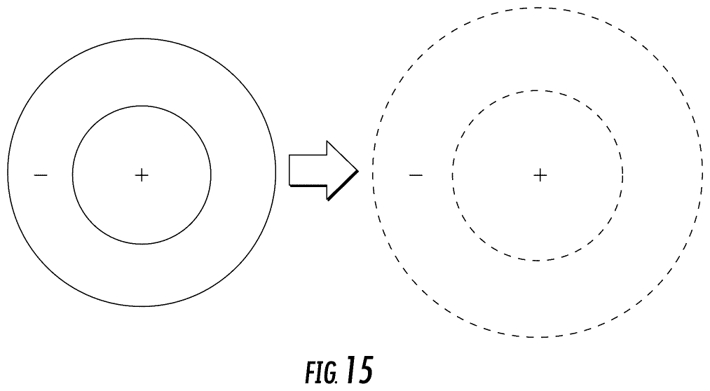

In various embodiments, a crossbar structure combines the effect of input voltages into output currents. FIG. 16 illustrates such an example circuit. The example circuit 1600 of FIG. 16 comprises a crossbar 1602 (similar to those described above) connected to an artificial LGN cell 1604. In various embodiments, the crossbar structure has programmable connections at the crossings 1606. In various embodiments, memristor+rectifier connections are preferred to avoid the sneak path effect.

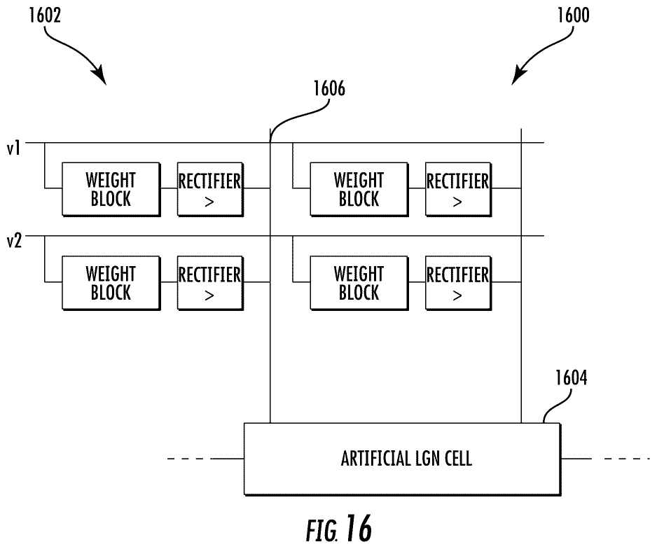

FIG. 17 is a block diagram of an example variable-resolution cell for attentive/pre-attentive processing, such as in LGN module 108. The example LGN cell 1700 receives a signal from a sensor of the visual data acquisition module 106, and the signal is provided to a first FB-controlled switch 1702 and a second FB-bar-controlled switch 1704. Feedback routes the signal (via the first FB-controlled switch 1702 and the second FB-bar-controlled switch 1704) toward the correct processing path (to save energy avoiding unnecessary processing).

The example LGN cell 1700 further comprises a high-resolution RF response block 1706 (also referred to herein as block 1A) and a low-resolution RF response block 1708 (also referred to herein as block 1B). In the illustrated embodiment, the output RF_{LR} of block 1B goes to a variable gain amplifier 1714 (also referred to herein as block FB2).

The output RF_{HR} of block 1A or the output of block FB2 goes to a contrast response block 1712 (also referred to herein as block 2), based on the state of a third FB-controlled switch 1710. The third switch 1710 can be removed if the outputs of blocks 1A and 1B do not interfere with each other. Two different feedback signals (OV FB and NON-OV FB) received from overlapping and non-overlapping upper-layer cells are provided to a feedback processing block 1716 (also referred to herein as block FB1), and block FB1 provides its output to block FB2.

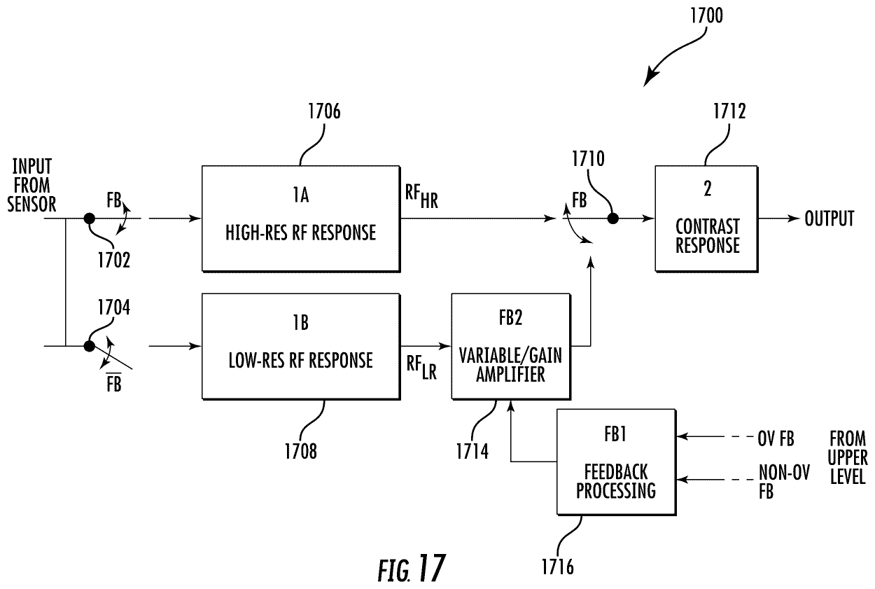

FIG. 18 is a block diagram of an example crossbar circuit 1800 that may be used with an LGN cell. The crossbar circuit 1800 is similar to those described above and comprises two voltage input lines v1, v2 and four current output lines I_{A}, I_{B}, I_{C}, and I_{D}. Regions A, B, C, and D (described below) correspond to distinct columns in the crossbar matrix and in turn to the four current output lines I_{A}, I_{B}, I_{C}, and I_{D} shown in FIG. 18.

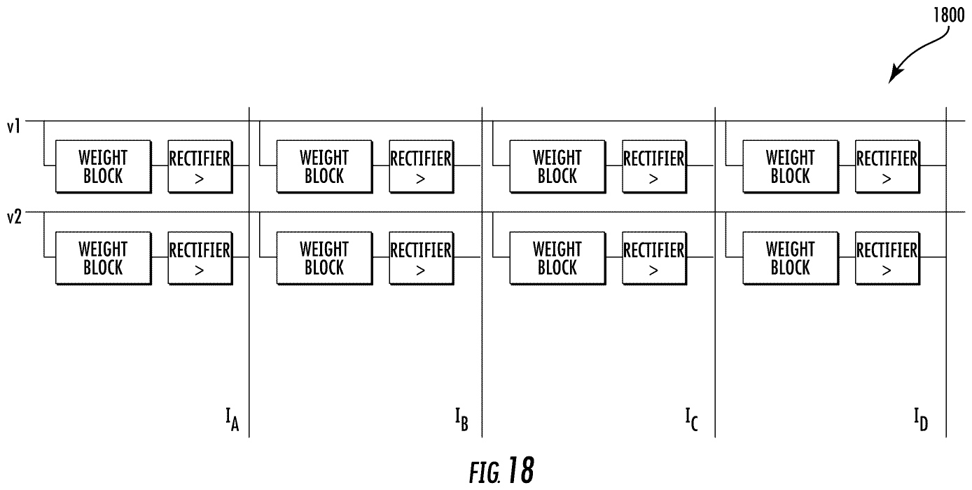

FIG. 19 illustrates how the weights for each of regions A, B, C, and D are determined. In various embodiments, the weights of each excitatory (+) or inhibitory (−) connection, respectively when the resolution is high (HR) or low (LR), will be W⁺_{HR}, W⁻_{HR}, W⁺_{LR}, or W⁻_{LR}. Then, depending on the attentive state, the weights will be as indicated in FIG. 19 (where ‘/’ is for ‘alternatively’). In various embodiments, depending on the high- or low-resolution condition, a region of the input sensor can be part of the center or surrounding of the cell, or not be considered at all.

In various embodiments, region A is always part of the center but has different positive weights depending on the high- or low-resolution condition (value of the HR signal); B is in the center (so with positive weights) when in low resolution, in the surrounding (with corresponding negative weights) when in high resolution; C is always in the surrounding, with different negative weights depending on HR; and D in the surrounding only in low-resolution with negative LR weight (i.e., it does not exist in high resolution). In various embodiments, the luminosity (current) average in the center and surrounding regions must be calculated (i.e., they are used in the denominator of the Michelson's definition of contrast above).

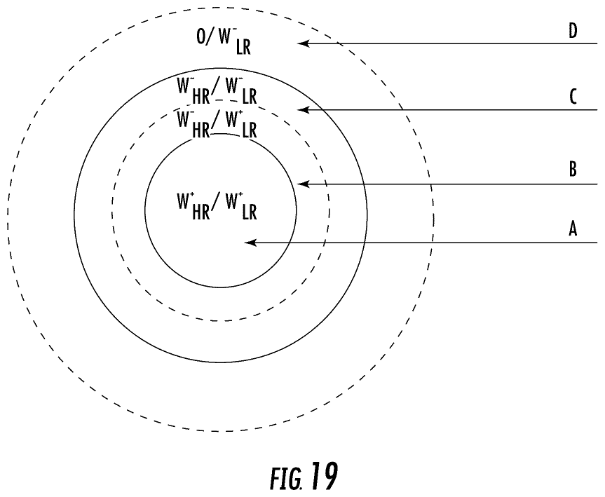

FIG. 20 is a block diagram of an example implementation of the low-resolution RF response block 1708 (block 1B) of FIG. 17 (the high-resolution RF response block 1706 (block 1A) of FIG. 17 will have a similar implementation). The example circuit 2000 of FIG. 20 comprises multiple current mirrors that receive the currents I_{A}, I_{B}, I_{C}, and I_{D} from the current output lines of FIG. 18 and determine the current values C_{LR} that is used as Cⁿ in the numerator of the equation above for calculation R(C) and C_{LR} that is used as Cⁿ in the denominator of the equation above for calculation R(C).

In various embodiments, the input current mirrors have some current gain. For example: I_{A} is multiplied by a factor K⁺_{LR}:K0 (ratio between the two gate areas in the respective transistors). This is because central (excitatory) and peripheral (inhibitory) areas have different amplifications. In various embodiments, once the signals have been amplified, the currents are summed algebraically in the proper way, exploiting Kirchhoff's law of nodes. For example, in the left-hand part of the circuit, I_{A} and I_{B}, after proper multiplication, flow downward (lines outflowing from the lower edge of the 1:1:1 blocks) into a same node.

In various embodiments, currents I_{C} and I_{D} flow outside the same node. The output (NUMERATOR) is then I_{A}−I_{B}+I_{C}−I_{D} (gains omitted) that is just the numerator in the contrast formula. The denominator is built in a similar way, except that, exploiting the property of current mirrors of reversing the current verse from input to output, the currents are all summed into the node (all are inflowing, the only outflowing line is the output (the denominator value)).

In various embodiments, the contrast response block 1712 (block 2) of FIG. 17 determines R(C) using the equation above, which expresses the brain-like response to contrast C, where n is well approximated by 2. Conceptually, the function of the contrast response block 1712 can be parted into two sub-blocks: (1) the calculation of C, and (2) the calculation of response to C according to the formula. In various embodiments, if the value of C is encoded by a voltage or current, there are many possible circuital implementations (analog, in particular) to calculate the response.

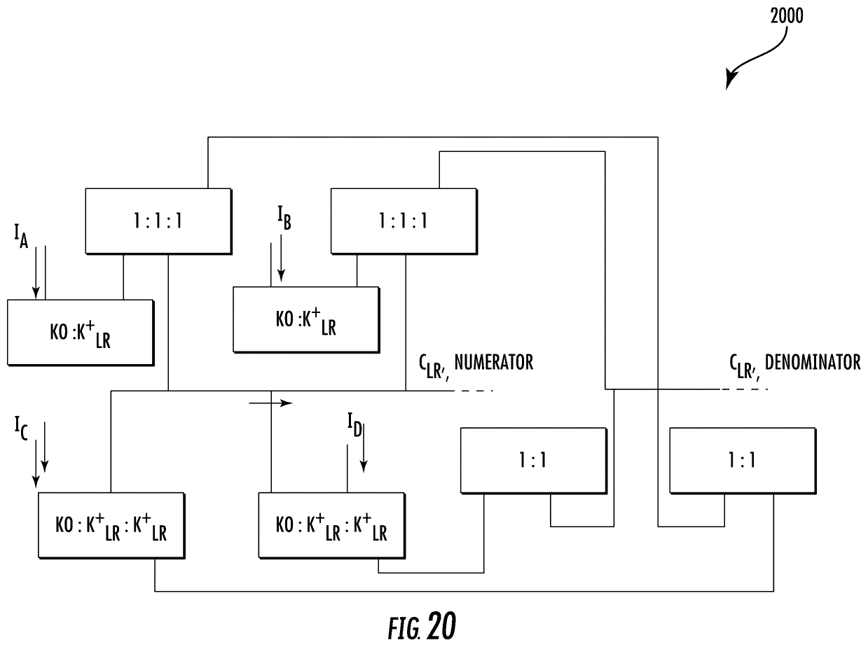

FIG. 21 is a block diagram of an example implementation of the feedback processing block 1716 (block FB1) of FIG. 17. The example implementation of the feedback processing block 1716 shown in FIG. 21 is for a synchronous feedback scheme. The example circuit 2100 of FIG. 21 comprises a feedback read overlapping (FB read OV) block 2102 with a switch 2104 to selectively provide a FB signal to the FB read OV block 2102, a feedback read non-overlapping (FB read NON-OV) block 2106 with a switch 2108 to selectively provide a FB signal to the FB read NON-OV block 2106, and a gain regulator block 2110. In various embodiments, the OV and NON-OV feedback will have, in general, a different effect on the gain regulation. As a mere example, the OV feedback could decrease the gain while the NON-OV increases the gain (both by multiplication but according to different coefficients). The two different read blocks (2102 and 2106) express this differently. In various embodiments, the two different read blocks (2102 and 2106) read the two types of feedback signals but with different sensitivity, or, from another angle, preprocess them differently. In various embodiments, the FB-controlled switch enables the two different read blocks (2102 and 2106) during the feedback phase only, in an asynchronous scheme.

The FB read OV block 2102 and the FB read NON-OV block 2106 detect the amount of feedback signals (intensity or average or the like) from the upper level when enabled by the FB signal. When FB is low, they are reset. The gain regulator block 2110 sends a gain regulation signal (GAINREG) to the variable gain amplifier (FB2) 1714. In various embodiments, in this synchronous scheme there is, at some level, an FB signal enabling the feedback detection phase (where it is depends on the FB configuration used). The gain regulator block 2110 takes care properly of max and min (saturation) gain values.

In various embodiments, the variable gain amplifier 1714 (block FB2) multiplies the signal (RF_{LR}) from the low-resolution RF block 1708 by a factor depending on the GAINREG signal from the gain regulator block 2110. In various embodiments, the variable gain amplifier 1714 (block FB2) comprises any suitable variable gain amplifier.

As described above, in various embodiments the Gabor filters module 110 detects small linear pieces of the border of an object in the image by applying Gabor functions, or the like, with linearly oriented alternate excitatory and inhibitory connection areas.

Convolving the image with a Gabor filter, using well-known Gabor filter equations, helps detect the borders of the image, as a contrast of color or luminance. In various embodiments, applying Gabor filter of sufficiently small size with different orientation helps decompose the borders into approximately straight pieces, which are then provided as inputs to the V1 module.

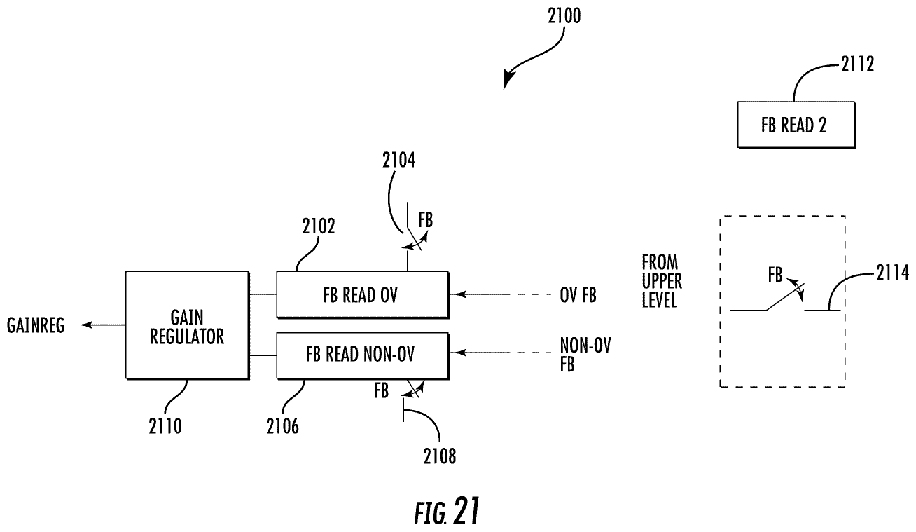

FIG. 22 is a block diagram of an example Gabor filters module 110 of FIG. 1, in accordance with example embodiments of the present disclosure. (In various embodiments, the same scheme as illustrated in FIG. 22 could apply to V3 segmentation cells.) The example circuit 2200 of FIG. 22 comprises a crossbar structure 2202 (similar to those described above), a summing block 2204, and optionally a thresholding block 2206. In various embodiments, the two columns of the crossbar structure 2202 and the summing block 2204 encode the sum of the excitatory and inhibitory inputs, respectively. The weights can encode the exp x cos-distributed coefficients that are used in the Gabor filter equations. In various embodiments, the optional thresholding block 2206 passes the difference between the excitatory and inhibitory subfields through a nonlinear, monotonic, thresholding block.

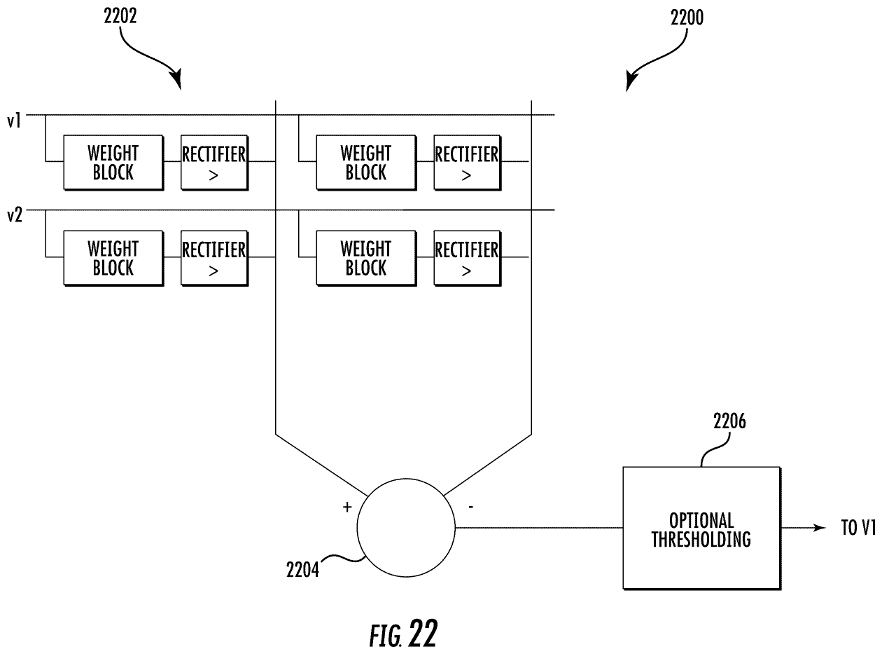

Referring now to FIGS. 23-26, various aspects of artificial non-linear neurons of an example system for image analysis are illustrated in accordance with example embodiments of the present disclosure. In various embodiments, the artificial non-linear neurons are used in the V1, V2, and V4 modules.

Conventional artificial neural networks descend from Rosenblatt's perceptron, which in turn, is based on the conception at that time of biological neurons. The ‘point neuron’ model assumes that dendrites convey weighted inputs towards the soma. The soma combines the inputs linearly and passes them through a nonlinear thresholding function. However, newer research has shown that natural neurons are far more complex and computationally far more powerful. Much, if not most, of the computation in biological neurons occurs inside dendrites, which are far from just passive wires. In dendrites of biological neurons, excitatory (ex) and inhibitory (in) inputs are combined in a way subtly depending on their reciprocal position with respect to the soma.

FIG. 23 illustrates a simplified view of a biological-like neuron 2300 with five active dendritic branches (or simply dendrites) 2302 connected to a soma 2304. (Five dendrites is an arbitrary amount for illustrative purposes. Each branch 2302 is to be considered an active conductor, receiving excitatory and inhibitory connections throughout its length and bringing their (nonlinear) effect to the soma. The dendrites can produce nonlinear spikes 2306 depending on how the inputs combine along the dendrites. The spikes 2306 are fed to the soma 2304. The effect of single inputs depends on their position along the dendritic tree with respect to the soma. The way inputs combine depends on their reciprocal position in relationship with the soma.

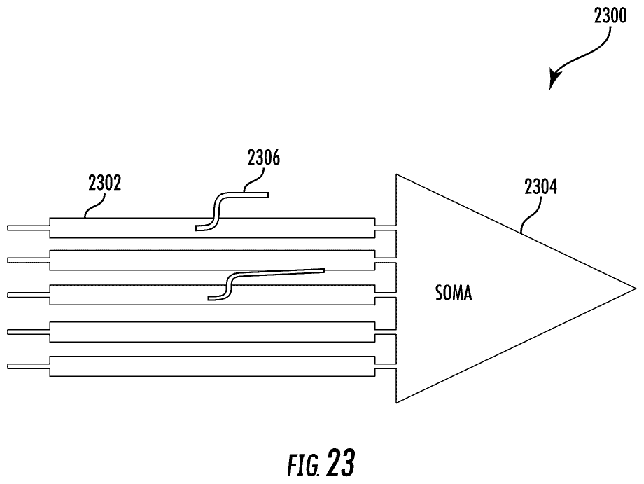

FIG. 24 illustrates an example block diagram of portion of an example artificial neuron 2400 comprising an active dendritic branch 2402 that comprises four dendritic sub-branches 2404. In various embodiments, the dendritic branches must reproduce the interplay between excitatory and inhibitory inputs of natural dendrites. In various embodiments, sub-branches 1 to 4 are progressively less proximal (more distal) with respect to the soma. Each sub-branch receives a part of the excitatory and inhibitory inputs, according to their topology. The division into four sub-branches is merely illustrative, and fewer or (more likely) more sub-branches would be used.

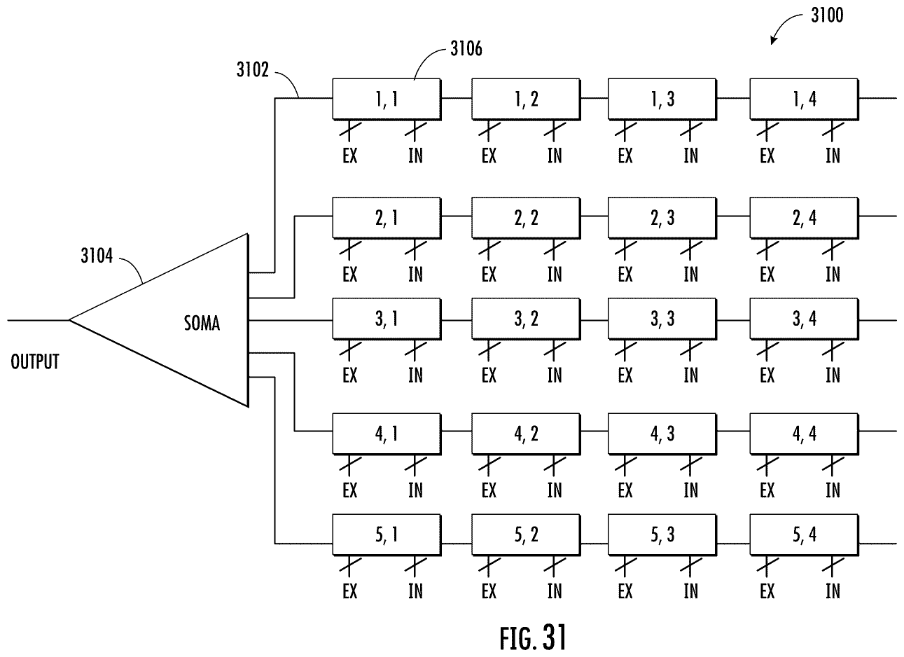

FIG. 31 illustrates another simplified view of a neuron 3100 that combines the concepts of FIGS. 23 and 24. In FIG. 31, the neuron 3100 has five active dendrites 3102 connected to a soma 3104. Each of the five dendrites 3102 has four sub-branches 3106, each with excitatory and inhibitory inputs.

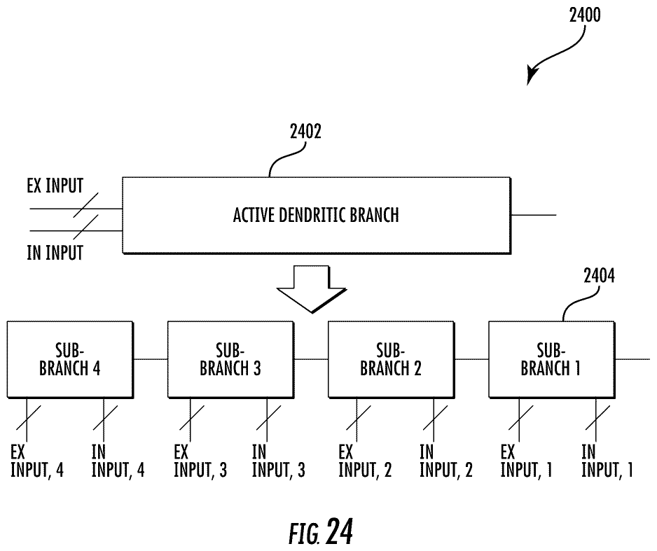

FIG. 25 illustrates an example equivalent circuit of two example sub-branches of an example dendrite. The example equivalent circuit 2500 comprises a first sub-branch example equivalent circuit 2502A and a second sub-branch example equivalent circuit 2502B. Each sub-branch example equivalent circuit comprises a variable inhibitory resistance R_{in,1} or R_{in,2}, a fixed resistance R_{L,1} or R_{L,2}, a variable excitatory resistance R_{NMDA,1} or R_{NMDA,2}, an inhibitory voltage source E_{I} in series with the variable inhibitory resistance R_{in,1} or R_{in,2}, and a membrane transverse voltage source Eₘ in series with the fixed resistance R_{L,1} or R_{L,2}. The term R_{NMDA} is a reference to standard neuroscientific terminology (NMDA stands for N-methyl-D-aspartate, a type of nonlinear conductance transversal to the neural membrane) to emphasize the neuromorphic nature of the model used here. In various embodiments, Ra,1 and Ra,2 are axial conductances connecting the different sub-branches, and are constant. In various embodiments, Rin resistances vary linearly according to the intensity of the inhibitory inputs applied to the sub-branch. The larger the inhibitory input, the larger (linearly) the conductance or the smaller its reciprocal (the resistance). Conversely, in various embodiments, R_{NMDA} is modulated by the excitatory inputs. Also in this case, the excitatory inputs multiply the conductance (or divide the resistance). However, there is also a non-linear voltage-dependent behavior. A voltage V₁ is applied to the first sub-branch example equivalent circuit 2502A and a voltage V₂ is applied to the second sub-branch example equivalent circuit 2502B. In various embodiments, it is assumed that Em=EI=−70 mV (as in natural neurons). In various embodiments, there is no generator in series with R_{NMDA,1} or R_{NMDA,2} since the equivalent battery voltage is assumed 0 in the literature.

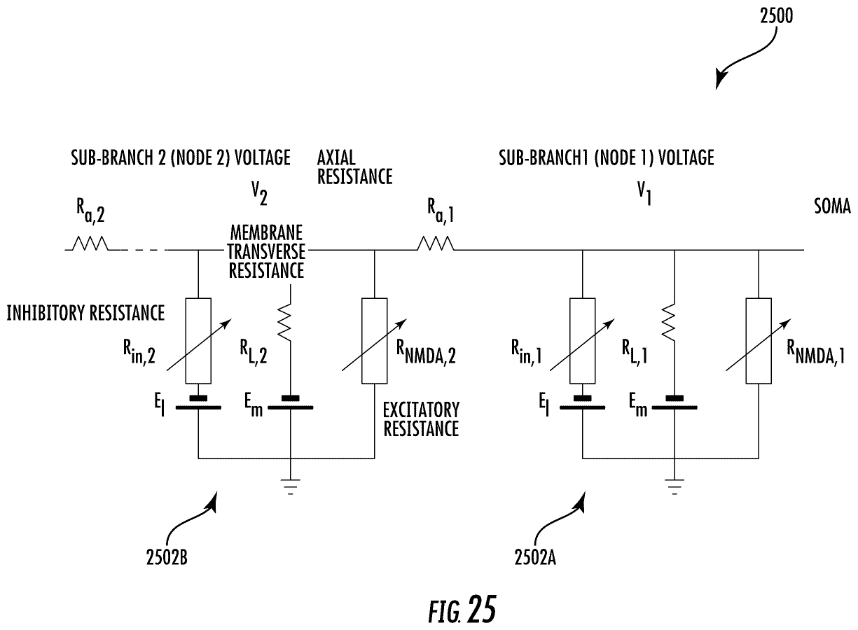

FIG. 26 illustrates an example block schematic of an example dendritic analog electronic circuit. The example block schematic circuit 2600 of FIG. 26 comprises a first sub-branch example equivalent circuit 2602A and a second sub-branch example equivalent circuit 2602B. The circuit 2600 of FIG. 26 is nearly identical to the circuit 2500 of FIG. 25, except that circuit 2600 of FIG. 26 shows the inhibitory current Iin,1 or Iin,2 and the excitatory current I_{ex,1} or I_{ex,2} supplied to each sub-branch, and a single voltage source E is in series with variable inhibitory resistance R_{in,1} or R_{in,2}, and with the fixed resistance R_{L,1} or R_{L,2}. In various embodiments, a voltage source is required, applying voltage E=El=Eₘ<0, if the circuit requires it. In various embodiments, the variable inhibitory resistance is a linear Voltage Controlled Resistor (VCR) (e.g., Rin in FIGS. 25 and 26). In various embodiments, the VCR Rᵢₙ is controlled by I_{in,1} with inverse logic (the larger the current, the lower the resistance). In various embodiments, the VCR can be implemented in any of the many ways known in the literature to implement VCRs.

In various embodiments, the inhibitory conductance increase linearly with the inhibitory current input, as expressed by: G_{in,n}=1/R_{in,n}=g_inI_{in,n}, where G_{in,n} is the inhibitory conductance in the nth sub-branch, R_{in,n} is the variable inhibitory resistance in the nth sub-branch, g_in is the elementary inhibitory conductance, and linn is the inhibitory current for the nth sub-branch. Any suitable circuital solution to implement a linearly variable conductance may be used, and approximate linearity may be acceptable. In various embodiments, Rᵢₙ introduces the effect of inhibitory inputs. The neuron receives in all branches both excitatory and inhibitory inputs. The effect of the inhibitory is that they increase the Gin conductivity linearly (or decrease Rin correspondingly). The larger the inhibitory inputs, the lower Rin, A lower Rin drains more current and makes it harder for the upper node to increase its own voltage. That is why inhibitory effects increase the triggering threshold of dendritic spikes and in some cases (depending on where the inhibitory inputs are placed with respect to the spike initiation site) decrease their amplitude as well.

In various embodiments, a variable excitatory conductance is selected according to a sigmoid curve as expressed by G_{ex,n}=1/R_{ex,n}=g_{NMDA}, where G_{ex,n} is the excitatory conductance in the nth sub-branch, R_{ex,n} is the variable excitatory resistance in the nth sub-branch, and g_{NMDA} is the variable excitatory conductance. These are all proportional to

$$\frac{{I}_{ex , n}}{1 + exp ( - \frac{{V}_{n} - a}{b} )} ;$$

where I_{ex,n} is the excitatory current for the nth sub-branch and Vn is the voltage for the nth sub-branch. Parameters a and b describe the sigmoid curve: parameter a relates to the threshold voltage and parameter b to its steepness. The shape of the curve and the values used are all taken from neuroscientific literature. From neuroscientific literature, 12.5 millivolts (mV) is a reasonable value for b, while a can take different values (depending on the transmembrane ionic channel considered) such as 7 or 23.7 mV. The voltage values can be rescaled as appropriate for their electronic implementations in embodiments of the present disclosure. Vn is a control signal, along with the current, because of the nonlinearity of the curve. In various embodiments, the active impedance can be implemented in different ways, such as using amp-ops or exponential-response devices like bipolar junction transistors or complementary metal oxide semiconductor (CMOS) devices in weak inversion. In various embodiments, variable excitatory conductance is the mechanism by which excitatory inputs act on the dendrites and, ultimately, on neurons. Its nonlinear variation can produce a ‘snappy’ response: in proper conditions, the voltage at the node can increase quite abruptly producing the so-called dendritic spike. In various embodiments, the spike indicates that there is a significant local concentration of excitatory inputs-so, it has a computational meaning. In various embodiments, the characteristics of the spike depend on the inhibitory inputs too.

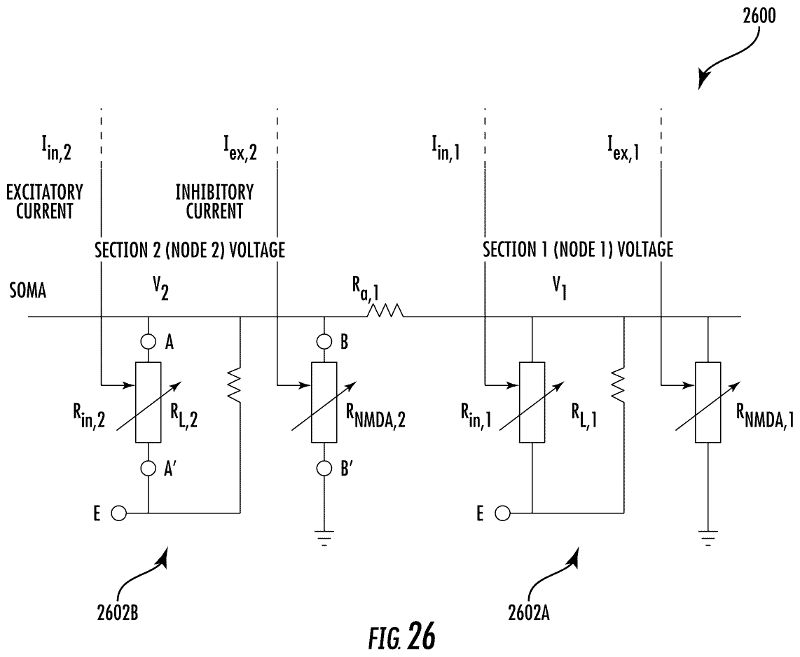

Referring now to FIG. 27-30, various aspects of segmentation cells of an example system for image analysis are illustrated in accordance with example embodiments of the present disclosure. In various embodiments, segmentation occurs in the V3 module 118 and the attractor finder module 120.

During the early analysis stage, the image is coarsely re-represented as medial axes and blobs. Non oriented cells, in particular, can help focus on blobs, while oriented cells are sensitive to middle axes or groups of axes. In various embodiments, the segment, blob, or axis must be associated to a position in the visual field. The receptive field has a central excitatory and a peripheral inhibitory area like in LGN cells. However, not all the V2 cells underneath the respective areas are connected. The orientation(s) of the segmentation cell is (are) chosen depending on the orientation(s) of the V2 cells underneath its center, as in the V1 to V2 to V4 hierarchy. In various embodiments, a Gaussian distribution is then applied, with the same standard deviation as the excitatory standard deviation in V1, V2, and V4.

It is assumed that the V2 cells in a region are sensitive to an orientation θ₀ as shown in FIG. 27 (their connections are Gaussian-distributed as shown). The choice of a single orientation is for simplicity, since V2 cells can be sensitive to more than one orientation. The center excitatory and surround inhibitory feedforward connections are obtained with the same central angle as V2. The fact that the inhibitory connections have the same standard deviation implies not much selectivity as to the angle, as in nature. This means that not all the V2 cells under overlapping with the V2's receptive field are feedforward connected. Conversely, the feedback covers the entire overlapping area.

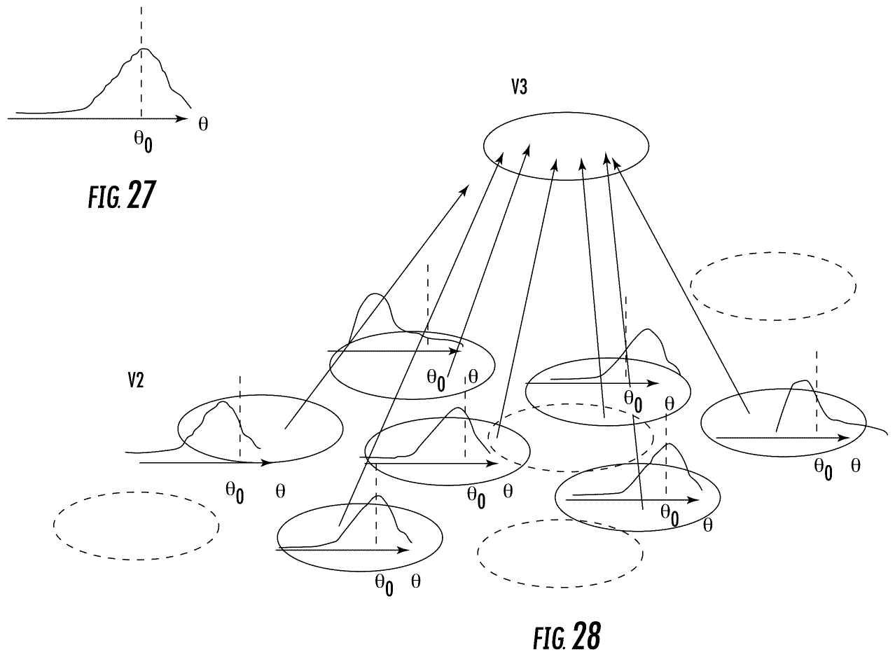

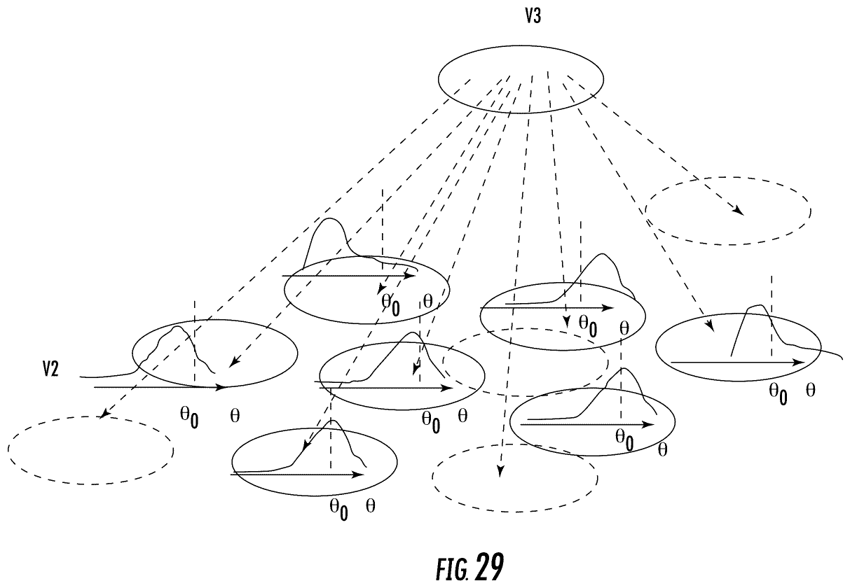

Referring now to FIG. 28, due to the Gaussian distribution, some V2 overlapping cells are selected, mostly with the same orientation as in the center. Only the feedforward connections are shown in FIG. 28 (the arrows from V2 to V3). Several V2 cells, though overlapped, are not used as inputs. In various embodiments, the V2 cells underneath are sensitive to more or less the same orientation, as shown by the Gaussian distributions, in case of an axis detector; blob detectors, instead, collect all orientations. However, V2 cells aggregate the outputs of different orientation sensitive V1 cells and can, then, respond to composite sets of orientations, like angles. Consequently, while FIG. 28 shows that a V2 cell distribution has a peak on one angular orientation, a second peak may exist, for example. In turn, a V3 cell can be sensitive to a combination of axial orientations—that is, it could react both to a single axis and to a combination of axes. In FIG. 29, the feedback connections are shown (the dashed arrows from V3 to V2) which cover the entire area underneath. The feedback goes to the attractor finder module 120.

In various embodiments, the feedback in the attractor finder module 120 is mapped in the same coordinate system. When an area receives joint feedback from some cells above, this indicates that an interesting ‘segment’ of image (elongated or spot-shaped) has been found, which can be worth focusing on for more detailed analysis. Then the area becomes somewhat an ‘attractor’ for the cortex. In various embodiments, the concept of attractor is also borrowed from neuroscience. An attractor in the cortex is (at least conceptually) a place where a group of neurons shows a prominent firing pattern. It is a place in the cortex where, for example, a pattern has been recognized or, perhaps, a new pattern has just been identified and is making its way to memory. In various embodiments, the concept is exploited by analogy: the attractor is a spot of intense neural activity, a local maximum which marks the centroid of a medial axis or blob.

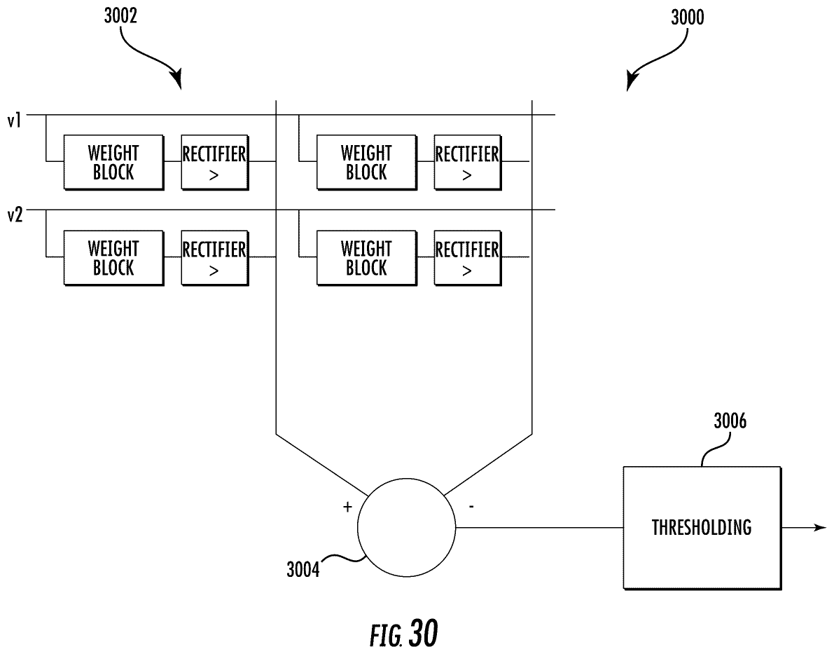

FIG. 30 is a block diagram of an example of a V3 cell in block 118 of FIG. 1, in accordance with example embodiments of the present disclosure. The example circuit 3000 of FIG. 30 comprises a crossbar structure 3002 (similar to those described above), a summing block 3004, and a thresholding block 3006. In various embodiments, the two columns of the crossbar structure 3002 and the summing block 3004 encode the sum of the excitatory and inhibitory inputs, respectively. The thresholding block 3006 passes the difference between the excitatory and inhibitory subfields through a nonlinear, monotonic, thresholding block. In various embodiments, the response of the single cell can be a simple algebraic sum of the excitatory and inhibitory regions, clipped to positive or null values in case most input comes from the inhibitory region.

In various embodiments, the V2 areas which receive most feedback are ‘attractors’ (they bear the presence of an interesting ‘image segment’). To locate the coordinates of attractors, at least approximately, an analogue solution may be used. Connections among cells based on the topology are possible and facilitated by the vicinity between abstract and physical layout, using a distributed layout and techniques for lateral connection. Output crossbars can be used, as for lateral connections, so that the cells with the same (or similar) x (or y) provide their feedback to the same line. Cells with the same x (or y) converge on the same horizontal (or vertical) line. The feedback intensity corresponding to the different x and y is collected and analog to digital conversion is performed before the values are passed to the controller 102. The coordinates corresponding to the most intensive feedback values are centroids of interesting image segments, or blobs.

Various embodiments of the present disclosure described above relate to calculating the magnitude (and threshold) of dendritic spikes. However, natural dendritic spikes have a time course expressed by factor p(t), which can be written as a difference between two exponentials:

$$p ( t ) = K [ exp ( - t / {τ}_{1} ) - exp ( - t / {τ}_{2} ) ] ,$$

where the two time constants are such that τ₁>τ₂.

In FIG. 31, for example, each dendrite feeds the soma with the magnitude (peak height) of the dendritic spike generated which amount to a static model of a natural neuron. To include a time variation, a block is inserted at the proximal (close to soma) end of each dendrite to produce a spike.

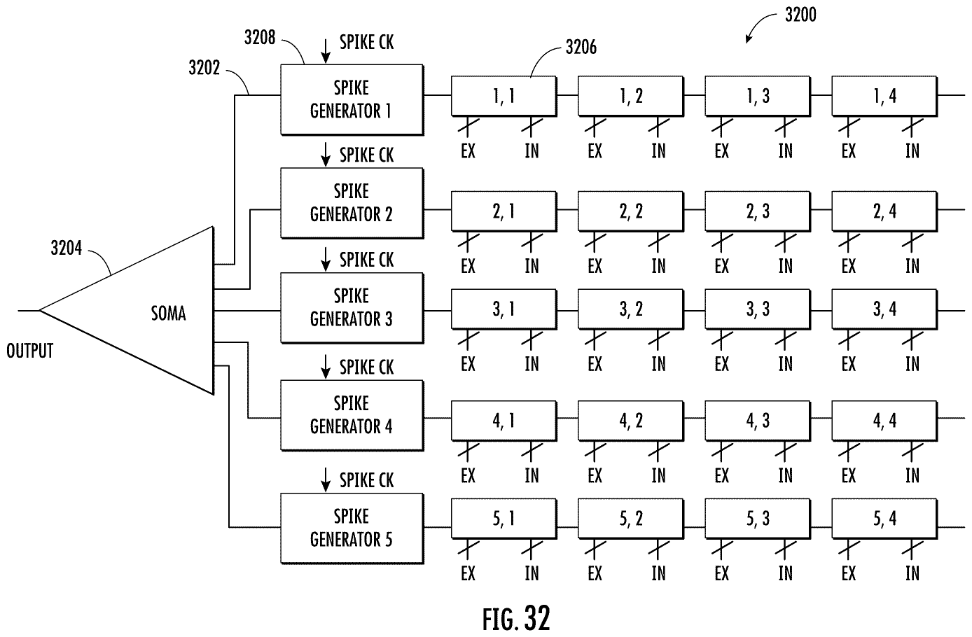

FIGS. 32-35 illustrate various aspects of time-responsive artificial non-linear neurons of an example system for image analysis, in accordance with example embodiments of the present disclosure. FIG. 32 illustrates another simplified view of a neuron 3200 with spike generator blocks. In FIG. 32, the neuron 3200 has five active dendrites 3202 connected to a soma 3204, with each of the five dendrites 3202 having four sub-branches 3206, each with excitatory and inhibitory inputs. As seen in FIG. 32, a spike generator 3208 is inserted at the proximal end of each dendrite 3202 and each spike generator 3208 receives a spike clock (ck) signal.

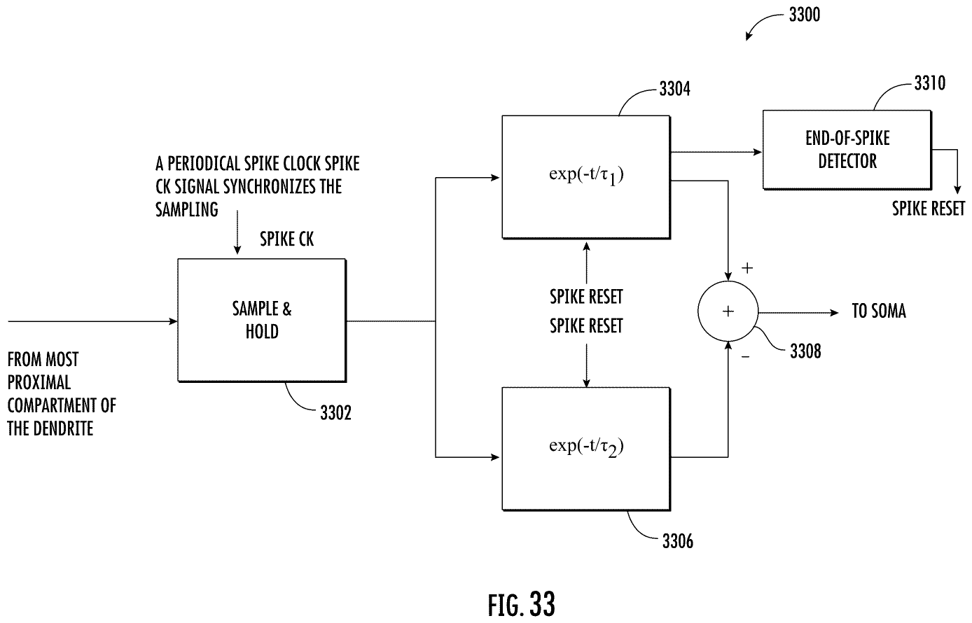

FIG. 33 illustrates a block diagram of a spike generator in accordance with example embodiments of the present disclosure. The spike generator 3300 of FIG. 33 comprises a sample and hold circuit 3302, a first exponential generator 3304 and a second exponential generator 3306 receiving an output of the sample and hold circuit 3302, a block 3308 which calculates the difference between the outputs of the first exponential generator 3304 and a second exponential generator 3306 and provides an output to the soma, and an end-of-spike detector 3310 receiving an output from the first exponential generator 3304 and providing a SPIKE RESET signal to the first exponential generator 3304 and the second exponential generator 3306. The input to the sample and hold circuit 3302 is directly connected to the most proximal compartment of the dendrite, however, the effect of all compartments propagates towards the soma so that the spike detected in FIG. 33 is actually the combined result of what happens along the entire dendrite. A periodical spike clock SPIKE CK signal is input to the sample and hold circuit 3302 to synchronizes the sampling. The end-of-spike detector 3310 is connected to and monitors the decay of the slower exponential generator to reset both exponential generators.

In various embodiments, any suitable circuit, such as a classical analog sample and hold circuit, may be used as the sample and hold circuit 3302. In various embodiments, the difference between the output of the first exponential generator and the second exponential generator is calculated using any suitable circuitry, such as a classical analog block.

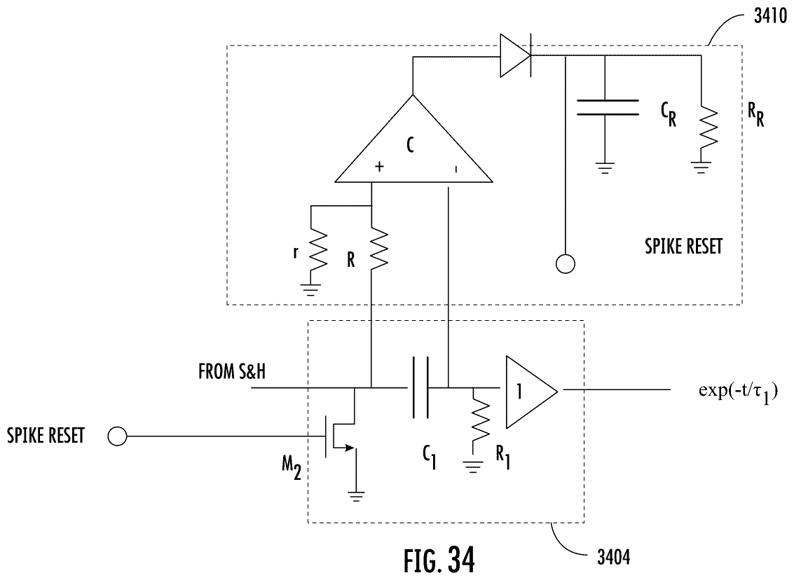

FIG. 34 illustrates one example circuit of a first exponential generator 3404 (the second exponential generator would have a similar configuration) and one example circuit of an end-of-spike detector 3410. In the end-of-spike detector 3410, r<<R, so that the comparator goes high when the voltage across R1 is smaller than a small fraction of the sample and hold (S&H) output, i.e., when the capacitor is nearly fully charged or the exponential is “exhausted.” The SPIKE RESET then discharges capacitors C₁ and C₂ quickly. SPIKE RESET is then discharged with time constant R_{R}C_{R} that is shorter than the spike duration.

In various embodiments, spikes can be produced by a spike generator at different instances in different dendritic branches. It may be important to detect the relative spike timing and make the neuron react only when the spikes are synchronized. Applications of such time-responsive artificial non-linear neurons range from sound detection, to movement detection in images, to any case in which time is an essential variable and the problem cannot be recast in (quasi-) static terms.

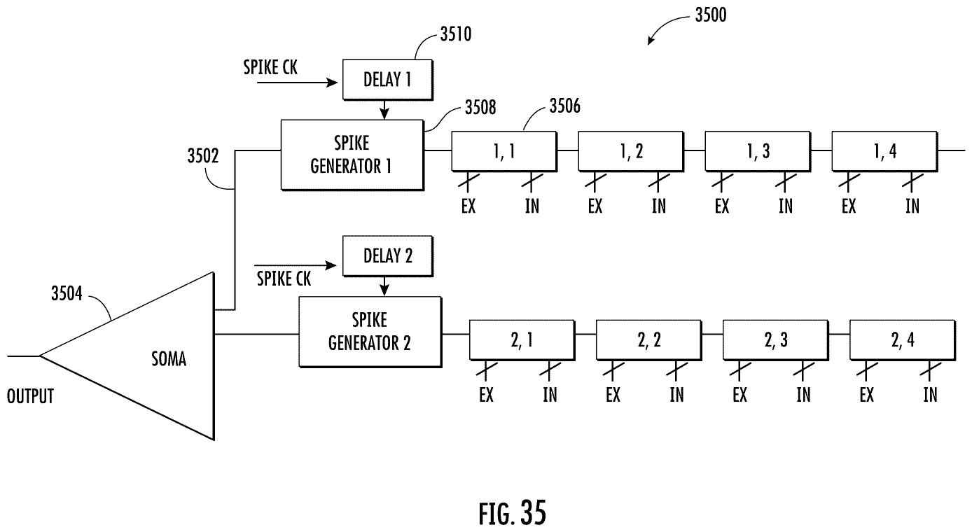

In various embodiments, the spike clock signal reaching the different branches can be delayed to variable degrees. FIG. 35 illustrates another simplified view of a neuron 3500 with spike generator blocks and delay blocks. In FIG. 35, the neuron 3500 has five active dendrites 3502 connected to a soma 3504, with each of the five dendrites 3502 having four sub-branches 3506, each with excitatory and inhibitory inputs. As seen in FIG. 35, a spike generator 3508 is inserted at the proximal end of each dendrite 3502. Before each spike generator 3208 receives a spike clock signal, the spike clock signal passes through a delay block 3510. Each delay block 3510 shifts the instant at which the S&H output is enabled by a time interval with respect to the phase of the spike clock. The delay block can be implemented using any suitable circuitry, such as a simple analog block.

### CONCLUSION

Many modifications and other embodiments of the disclosures set forth herein will come to mind to one skilled in the art to which these disclosures pertain having the benefit of teachings presented in the foregoing descriptions and the associated drawings. Although the figures only show certain components of the apparatus and systems described herein, it is understood that various other components may be used in conjunction with the system. Therefore, it is to be understood that the disclosures are not to be limited to the specific embodiments disclosed and that modifications and other embodiments are intended to be included within the scope of the appended claims. Moreover, the steps in the method described above may not necessarily occur in the order depicted in the accompanying diagrams, and in some cases one or more of the steps depicted may occur substantially simultaneously, or additional steps may be involved. Although specific terms are employed herein, they are used in a generic and descriptive sense only and not for purposes of limitation.

While various embodiments in accordance with the principles disclosed herein have been shown and described above, modifications thereof may be made by one skilled in the art without departing from the spirit and the teachings of the disclosure. The embodiments described herein are representative only and are not intended to be limiting. Many variations, combinations, and modifications are possible and are within the scope of the disclosure. Alternative embodiments that result from combining, integrating, and/or omitting features of the embodiment(s) are also within the scope of the disclosure. Accordingly, the scope of protection is not limited by the description set out above.

Additionally, the section headings used herein are provided for consistency with the suggestions under 37 C.F.R. 1.77 or to otherwise provide organizational cues. These headings shall not limit or characterize the disclosure(s) set out in any claims that may issue from this disclosure.

While this detailed description has set forth some embodiments of the present disclosure, the appended claims cover other embodiments of the present disclosure which differ from the described embodiments according to various modifications and improvements. For example, the appended claims can cover any form of image detection system.

Within the appended claims, unless the specific term “means for” or “step for” is used within a given claim, it is not intended that the claim be interpreted under 35 U.S.C. 112, paragraph

What is claimed is:

1. A computer-implemented method for image analysis, the method comprising:
acquiring an image to be analyzed, the image having a first resolution;
blurring the acquired image to create a blurred image having a second resolution less than the first resolution;
performing one or more image analysis actions on the blurred image;
storing results of the one or more image analysis actions performed on the blurred image as part of a neural fingerprint of the acquired image;
performing one or more image analysis actions on one or more portions of the acquired image; and
storing results of the one or more image analysis actions performed on one or more portions of the acquired image as part of the neural fingerprint of the acquired image.

2. The method of claim 1, wherein blurring the acquired image comprises convoluting the acquired image with larger kernels.

3. The method of claim 1, wherein performing one or more image analysis actions on the blurred image comprises:
decomposing one or more borders of the blurred image into linear pieces;
decomposing the one or more borders of the blurred image into one or more other, non-linear shapes; and
storing the one or more other, non-linear shapes as part of the neural fingerprint of the acquired image.

4. The method of claim 3, wherein performing one or more image analysis actions on the blurred image further comprises identifying one or more centers of symmetry of the blurred image, one or more medial axes of the blurred image, and/or one or more medial blobs of the blurred image.

5. The method of claim 4, wherein performing one or more image analysis actions on the blurred image further comprises detecting a shape of each of the one or more medial axes of the blurred image.

6. The method of claim 5, wherein performing one or more image analysis actions on the blurred image further comprises:
decomposing the one or more medial axes of the blurred image and/or the one or more medial blobs of the blurred image into linear pieces;
decomposing the one or more medial axes of the blurred image and/or the one or more medial blobs of the blurred image into one or more other, non-linear shapes; and
storing the one or more other, non-linear shapes as part of the neural fingerprint of the acquired image.

7. The method of claim 6, wherein performing one or more image analysis actions on the blurred image further comprises finding a centroid of each of the one or more medial axes of the blurred image and/or each of the one or more medial blobs of the blurred image; and
wherein performing one or more image analysis actions on one or more portions of the acquired image comprises, for each of the one or more medial axes of the blurred image and/or each of the one or more medial blobs of the blurred image, (i) centering a visual field on a portion of the acquired image corresponding to the centroid of a selected one of (a) the one or more medial axes of the blurred image or (b) the one or more medial blobs of the blurred image, (ii) decomposing the portion of the acquired image upon which the visual field is centered into linear pieces (iii) decomposing the portion of the acquired image upon which the visual field is centered into one or more other, non-linear shapes, and (iv) storing the one or more other, non-linear shapes as part of the neural fingerprint of the acquired image.

8. An apparatus for image analysis, the apparatus comprising at least one processor and at least one non-transitory memory comprising program code, wherein the at least one non-transitory memory and the program code are configured to, with the at least one processor, cause the apparatus to at least:
acquire an image to be analyzed, the image having a first resolution;
blur the acquired image to create a blurred image having a second resolution less than the first resolution;
perform one or more image analysis actions on the blurred image;
store results of the one or more image analysis actions performed on the blurred image as part of a neural fingerprint of the acquired image;
perform one or more image analysis actions on one or more portions of the acquired image; and
store results of the one or more image analysis actions performed on one or more portions of the acquired image as part of the neural fingerprint of the acquired image.

9. The apparatus of claim 8, wherein blurring the acquired image comprises convoluting the acquired image with larger kernels.

10. The apparatus of claim 8, wherein performing one or more image analysis actions on the blurred image comprises:
decomposing one or more borders of the blurred image into linear pieces;
decomposing the one or more borders of the blurred image into one or more other, non-linear shapes; and
storing the one or more other, non-linear shapes as part of the neural fingerprint of the acquired image.

11. The apparatus of claim 10, wherein performing one or more image analysis actions on the blurred image further comprises identifying one or more centers of symmetry of the blurred image, one or more medial axes of the blurred image, and/or one or more medial blobs of the blurred image.

12. The apparatus of claim 11, wherein performing one or more image analysis actions on the blurred image further comprises detecting a shape of each of the one or more medial axes of the blurred image.

13. The apparatus of claim 12, wherein performing one or more image analysis actions on the blurred image further comprises:
decomposing the one or more medial axes of the blurred image and/or the one or more medial blobs of the blurred image into linear pieces;
decomposing the one or more medial axes of the blurred image and/or the one or more medial blobs of the blurred image into one or more other, non-linear shapes; and
storing the one or more other, non-linear shapes as part of the neural fingerprint of the acquired image.

14. The apparatus of claim 13, wherein performing one or more image analysis actions on the blurred image further comprises finding a centroid of each of the one or more medial axes of the blurred image and/or each of the one or more medial blobs of the blurred image; and
wherein performing one or more image analysis actions on one or more portions of the acquired image comprises, for each of the one or more medial axes of the blurred image and/or each of the one or more medial blobs of the blurred image, (i) centering a visual field on a portion of the acquired image corresponding to the centroid of a selected one of (a) the one or more medial axes of the blurred image or (b) the one or more medial blobs of the blurred image, (ii) decomposing the portion of the acquired image upon which the visual field is centered into linear pieces (iii) decomposing the portion of the acquired image upon which the visual field is centered into one or more other, non-linear shapes, and (iv) storing the one or more other, non-linear shapes as part of the neural fingerprint of the acquired image.

15. A system for analyzing an image comprising:
a visual data acquisition module for acquiring the image to be analyzed;
a lateral geniculate nucleus (LGN) module for processing the image provided by the visual data acquisition module by passing the image through a bank of filters with a center-surround excitatory/inhibitory connection distribution;
a Gabor filters module for detecting a plurality of linear pieces of a border of an object in the image;
a V1 module for detecting a plurality of pieces of the border of a first complexity;
a V2 module for aggregating outputs of the V1 module to detect a plurality of pieces of the border that are larger and more complex than the plurality of pieces detected by the V1 module;
a V4 module for aggregating outputs of the V2 module to detect a plurality of pieces of the border larger and more complex than the plurality of pieces detected by the V2 module;
a V3 module for aggregating groups of adjacent outputs from the V2 module over variable areas; and
an attractor finder module for locating groups of adjacent V3 cells whose response exceeds a predetermined threshold.

16. The system of claim 15, further comprising a position control module for controlling which part of the image is analyzed.

17. The system of claim 15, wherein the V1 module, the V2 module, and the V4 module have identical structures.

18. The system of claim 15, wherein the Gabor filters module a plurality of linear pieces of a border by applying Gabor functions with linearly oriented alternate excitatory and inhibitory connection areas.

19. The system of claim 15, wherein the LGN module blurs at least a portion of the image.

20. The system of claim 15, wherein the V4 module aggregates a minority of outputs of the V1 module to detect a plurality of pieces of the border larger and more complex than the plurality of pieces detected by the V1 module.
